(19) United States
(12) Patent Application Publication
(10) Pub. No.: US 2010/0222454 A1
(43) Pub. Date: Sep. 2, 2010

(54) DEGRADATION ACCELERATOR FOR POLYMERS AND POLYMER ARTICLE COMPRISING IT

(75) Inventors: Massimiliano Sala, Castelnuovo Rangone (MO) (IT); Wiebke Wunderlich-Wippert, Lorrach (DE); Stefano Gardi, Bologna (IT)

Correspondence Address: BASF Performance Products LLC;Patent Department, 540 White Plains Road, P.O. Box 2005, Tarrytown, NY, 10591, US

(73) Assignee: CIBA CORPORATION, Tarrytown, NY (US)

(21) Appl. No.: 12/670,872

(22) PCT Filed: Jul. 24, 2008
(86) PCT No.: PCT/EP2008/059681

§ 371 Date: May 17, 2010

(30) Foreign Application Priority Data
Aug. 2, 2007 (EP) 07113692.3

(51) Int. Cl. C08K 5/07; C08K 5/3417; C08K 5/10; C08K 5/435; C08K 5/08

(52) U.S. Cl. 523/126; 523/125; 523/124

(57) ABSTRACT

Disclosed are a method for improving the degradation of natural and/or synthetic polymers or a polymer article made from such polymer(s) by light and/or heat and/or humidity, comprising the incorporation of a compound of formula (I) into said natural and/or synthetic polymers: Formula (I); wherein m is 1 or 2, n is 1 to 100, X is selected from certain benzophenone-derived moieties and R, R1; R2 are each selected from list of certain residues; novel compounds of said formula (I) and polymeric articles of improved degradability in the presence of light and/or heat and/or humidity being made of a composition comprising: A) a natural and/or a synthetic polymer and B) a degradation accelerator being a compound of said formula (I).

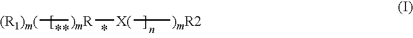

The present invention relates to a method for the degradation of natural and/or synthetic polymers, to novel compounds useful as degradation accelerator for said polymers and to a polymer article made of a composition containing a natural and/or a synthetic polymer and a degradation accelerator therefore, which polymer articles exhibit accelerated degradability in presence of light and/or heat and/or humidity.

Since many decades, plastic articles find widespread applications in everyday life because of their durability in use and cost effectiveness. With proper stabilization, most commercial plastics are made to last for years.

In recent years however, environmental concern has lead to the development of so called biodegradable materials, of diverse origin and nature, which will maintain their function and integrity during service life, but disintegrate after use into carbon dioxide and water, either triggered by chemical means or by microorganisms. It is however a problem is to establish a suitable equilibrium between biodegradability and integrity during service life.

Most biopolymers on the market today serve for short time applications, such as disposable cutlery, tableware, (fast) food packaging as well as trash and shopping bags. The materials used for these applications vary from blends of thermoplastic starch with synthetic or natural polyesters, polyesters derived from bacterial fermentation such as polyhydroxy esters or are based on monomers obtained from natural feedstock, which are converted in a successive step into a condensation polymer as for example in the case of polylactic acid. A common feature of all of these materials is the presence of heteroatoms, preferably oxygen or nitrogen, in the polymeric backbone, which render these materials susceptible to hydrolysis, microbial attack and hence decay to carbon dioxide and water, which justifies the property of “biodegradability”. One of the most diffused products for these short lifetime products is Mater-Bi®, and is a blend of modified starch blended with aliphatic polyesters supplied by Novamont (Italy). The mechanical properties of most of these materials are not virtually sufficient for applications that require a more elevated mechanic profile such as agricultural films. To overcome this obstacle, aliphatic-aromatic copolyesters, commercialized under the tradename Ecoflex® by BASF, are e.g. used as polyesters for these advanced applications. However, compromising between mechanical strength and biodegradability often leads to a decrease in biodegradation rate within a given timeframe. Therefore, also for these materials, an enhanced degradation rate would be desirable.

In the case of synthetic thermoplastics such as polyolefin homo- and copolymers, conventional degradation additives such as transition metal salts based on iron, cobalt, manganese, cerium, copper or nickel work well in many applications where degradation of the plastic is required. Since in these cases the polymer matrix itself is not inherently biodegradable via hydrolysis but has to proceed via oxidation reactions along the carbon-carbon chain. The polyolefin oxidation is catalyzed by the redox-cycle of polyvalent metal ions. The oxidation proceeds, and when the polymer chain has reached a certain molecular weight, degradation by microbes sets in. Many countries have however restrictive regulation on the uses of such transition metals for health reasons.

A different approach to enhance the biodegradation of synthetic thermoplastics, claimed since the early seventies, is the incorporation of aromatic photosensitizes like anthraquinone or benzophenone derivatives. The use of these additives, however, furnishes various inconveniences because they are generally compounds of low molecular weight. For example, an additive of relatively low boiling point or a sublimable additive undergoes evaporation, sublimation or the like when a resin is molded, formed or otherwise processed under heat. Furthermore, poor compatibility between the functional agent and the resin causes bleeding or blooming on the surface of the resin during its long-term use. Furthermore, blooming can cause additive leaching particularly undesirable when plastic products are used in contact with food or crops. Limitation is therefore imposed on the amount of the functional agent to be added. There has hence been a demand for the elimination or lessening of these problems.

Degradable plastic compositions are described in e.g. U.S. Pat. No. 4,042,765, WO-A-92/11,298, U.S. Pat. No. 4,495,311 and U.S. Pat. No. 3,993,634.

Oligomeric benzophenone derivatives have also been used already in polymer technology for different purposes.

JP-A-2000-248178 describes polyimide precursors having the following formula:

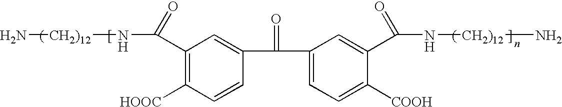

their preparation and a coating derived thereof.

U.S. Pat. No. 7,015,304 describes low-melt viscosity imide oligomers derived from the reaction of 2,3,3′,4′-benzophenonedianhydride and aromatic diamines for the production of polyimide matrix composites.

JP-A-10-195195 describes oligomeric compounds of formula:

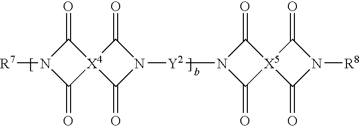

obtainable by reaction of one or more tetracarboxylic acid dianhydrides, diamines and monoamines and useful as modifiers for thermoplastic resins for lowering their melt viscosity and improving their crystallising properties. Specifically described are two compounds based on benzophenone tetracarboxylic acid dianhydride, a first one wherein R7 and R8 are C₁₈alkyl; X⁴ and X⁵ are -(phenyl)-CO-(phenyl)-, Y² is —CH₂-(phenylene)-CH₂— and b is 1, and a second one, wherein R7 and R8 are 2-ethylhexyl; X⁴ and X⁵ are -(phenyl)-CO-(phenyl)-, Y² is dodecanylene and b is 3.

It has now been found that oligomeric compounds comprising a benzophenone moiety in the molecule, namely the compounds of formula (I)

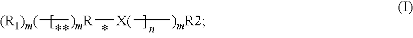

wherein
n is 1 to 100;
m is 1 or 2;
X is an m+1-valent group selected from the groups of formula (1), (2), (3) and (4):

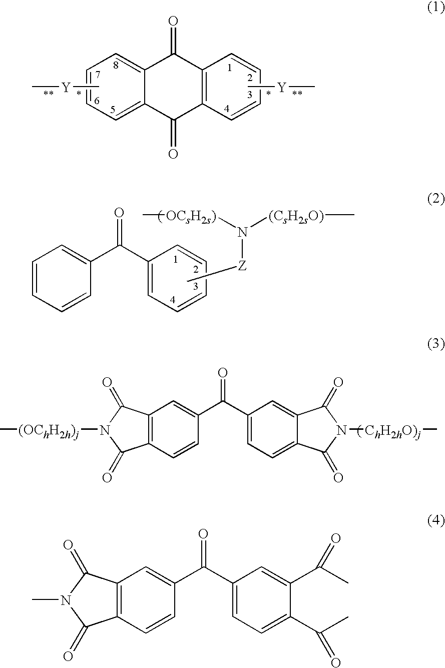

wherein
Y is a divalent group comprising 1 to 20 atoms selected from C, N, O, S and hydrogen atoms,

### Z is >(C═O) or >SO₂,

h is independently for each corresponding oxyalkylene moiety an integer from 2 to 4;
j is 0 or 1, and
s is independently for each corresponding oxyalkylene moiety an integer from 2 to 4;
R is m+1-valent group selected from:
-G-(C₂-C₃₄alkylene)-G-;
-G-(C₅-C₇cycloalkylene)-G-;
-G-(C₅-C₇cycloalkylene)-(k,k′-C₁-C₄alkylene)-(C₅-C₇cycloalkylene)-G-,
-G-(C₁-C₁₈alkylene)-(C₅-C₇cycloalkylene)-(C₁-C₁₈alkylene)-G-;
-G-(C₆-C₁₂arylene)-G-;
-G-(C₆-C₁₂arylene)-(k,k′-C₁-C₄alkylene)-(C₆-C₁₂arylene)-G-,
-G-(C₁-C₁₈alkylene)-(C₆-C₁₂arylene)-(C₁-C₁₈alkylene)-G-
   wherein said C₂-C₃₄alkylene or C₁-C₁₈alkylene groups can be unsubstituted or substituted by 1 or more substituents selected from Cl; Br; I; OH; NH₂, and C₁-C₄alkoxy, and said C₅-C₇cycloalkylene and C₆-C₁₂arylene groups can be unsubstituted or substituted by 1 or more substituents selected from Cl; Br; I; OH; NH₂, C₁-C₁₀alkyl, C₁-C₁₀alkenyl and C₁-C₁₀alkoxy,
   G is absent or is selected from —O— and >(C═O) and
   k (and k′) is 1 or 2; and
   the groups of the formulae:

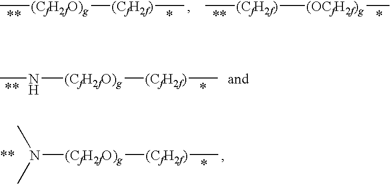

wherein each f is independently for each alkylene moiety of said groups an integer from 2 to 4, and g is from 1 to 10;
R1 is H; Cl; Br; I; OH; NH₂; a group selected from C₁-C₃₀alkyl, C₂-C₃₀alkenyl, C₁-C₃₀alkyloxy, C₂-C₃₀alkenyloxy, which groups may be unsubstituted or substituted by 1 or more of Cl; Br; I; OH; NH₂, NH(C₁-C₄alkyl), N(C₁-C₄alkyl)₂, COOH; COOC₁-C₄alkyl, C₁-C₄alkoxy; a group selected from C₃-C₁₂cycloalkyl, C₃-C₁₂cycloalkyloxy, C₅-C₁₂cycloalkenyl, C₅-C₁₂cycloalkenyl, C₆-C₁₂aryl, C₆-C₁₂aryloxy, which groups may be unsubstituted or substituted by 1 or more of Cl; Br; I; OH; NH₂, NH(C₁-C₄alkyl), N(C₁-C₄alkyl)₂, COOH; COOC₁-C₄alkyl, C₁-C₄alkyl or C₁-C₄alkoxy, or
R1 is a group —X3-R3-R4, wherein X3 is a group of formula (3) as defined above, and
R3 has one of the meanings of R wherein G is absent; and
R4 is H, NH₂, NH(C₁-C₄alkyl), N(C₁-C₄alkyl)₂, Cl, Br, I, OH, COOH, COOC₁-C₄alkyl; and
R2 is H, a group selected from C₁-C₃₀alkyl, C₂-C₃₀alkenyl, C₁-C₃₀alkyloxy, which groups may be unsubstituted or substituted by 1 or more of Cl; Br; I; OH; NH₂, NH(C₁-C₄alkyl), N(C₁-C₄alkyl)₂, COOH, COOC₁-C₄alkyl, C₁-C₄alkoxy; a group selected from C₃-C₁₂cycloalkyl, C₅-C₁₂cycloalkenyl, C₆-C₁₂aryl, which groups may be unsubstituted or substituted by 1 or more of Cl; Br; I; OH; NH₂, C₁-C₄alkyl or C₁-C₄alkoxy, or
R2 is a group —R5-R6, wherein
R5 has one of the meanings of R other than —C₂-C₃₄alkylene- and wherein G is absent; and
R6 is H, NH₂, NH(C₁-C₄alkyl), N(C₁-C₄alkyl)₂, Cl, Br, I, OH, COOH, COOC₁-C₄alkyl, C₁-C₄alkyl or C₁-C₄alkoxy; or

### R2 is —O—;

wherein the stars indicate the orientation of asymmetric groups R and Y in the formulae of said oligomeric compounds;
are excellent degradation accelerators for natural and/or a synthetic polymers and can readily overcome the problems described above with regard to the biodegradation of said polymers. An important advantage of said compounds found according to the invention is their strongly reduced tendency to volatilize out of the polymer material. Another important advantage is, that these compounds can readily be designed to meet a specific resin's specific needs.

In this sense, the present invention therefore relates to the use of a compound of the above formula (I) as a degradation accelerator for natural and/or a synthetic polymers, as well as to a method for improving the degradation of natural and/or synthetic polymers or a polymer article made of a composition comprising such polymer(s) by light and/or heat and/or humidity, said method comprising the incorporation of a compound of formula (I) into said natural and/or synthetic polymers. Said incorporation is carried out before manufacturing a polymer article from the composition comprising the natural and/or a synthetic polymer(s) and said compound of formula (I).

In yet a further aspect, the present invention relates to a polymer article which is degradable, triggered by light and/or heat and/or humidity, (a property also referred to hereinafter as “biodegradable”), and which article is made of a composition containing

(A) a natural and/or a synthetic polymer and
(B) a degradation accelerator, being a compound of the formula (I) as described above, in particular, a compound selected from the compounds of said formula (I) except for the compounds (a) and (b) of formula (II)

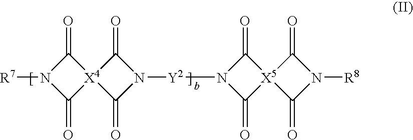

wherein
(a) R7 and R8 are C₁₋₈alkyl; X⁴ and X⁵ are -(phenyl)-CO-(phenyl)-, Y² is —CH₂— (phenylene)-CH₂— and b is 1, or
(b) R7 and R8 are 2-ethylhexyl; X⁴ and X⁵ are -(phenyl)-CO-(phenyl)-, Y² is C₁₂alkylene and b is 3.

The index n in formula (I) is 1 to 20. n can also be any natural number within said range, and must not necessarily be an integer. Non-integer values for n can be found e.g. in case of mixtures of two or more than two oligomers of formula (I) wherein e.g. two or more of said oligomers, although exhibiting repeating units of the same formula, exhibit a backbone of different length, i.e. consisting of a different number of said repeating units. The value of n can e.g. be determined from the number-average molecular weight (Mn) of the compound, which can be determined according to methods well known in the art, e.g. by gel permeation chromatography (GPC), according to the following formula:

n=[Mn_{(compound of formula (I))}−(m×MW_{(R1)})−MW_{(R2)}]/MW_{(RepUnit)}

wherein Mn_{(compound of formula (I))} means the number-average molecular weight of the compound, MW means the molecular weight of the bracketed moiety of said compound calculated from its formula, R1 and R2 mean the specific residues R1 and R2 of said compound and “RepUnit” means the specific repeating unit

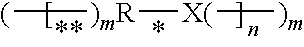

in the formula of said compound.

It is furthermore evident to a person skilled in the art that the index n can, in practice, only be determined with a certain experimental error in the measurement, depending on the specific method used for determining it. This is particularly important for low values of n, especially for n=1 or about 1. For the purposes of the present application the value of 1 for the lower boundary of the range for index n is therefore meant to include values below 1 too, notwithstanding the fact that such values for n would in theory be impossible. The deviation from the theoretic value for n can, in practice, be up to about +/−50%, i.e. values for n as low as 0.5 can experimentally be found, e.g. when working according to the method described above, and are thus included in the meaning of “1” for index n.

Preferably n is 1 to 20, more preferably 1 to 10, in particular >1 to 10, i.e. in the range of 1 to 7, for example, or from >1 to 7.

Preferably, X in formula (I) is a group selected from the groups

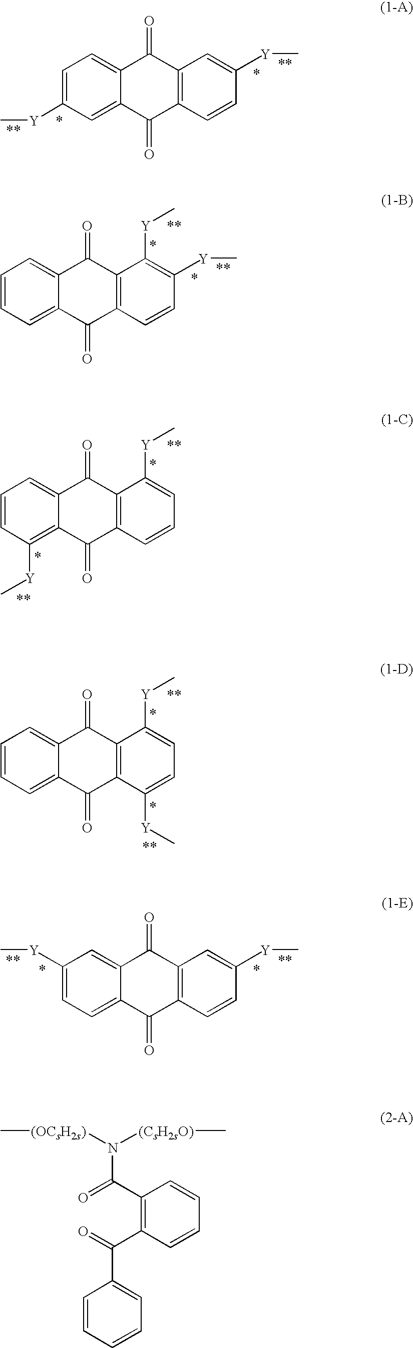

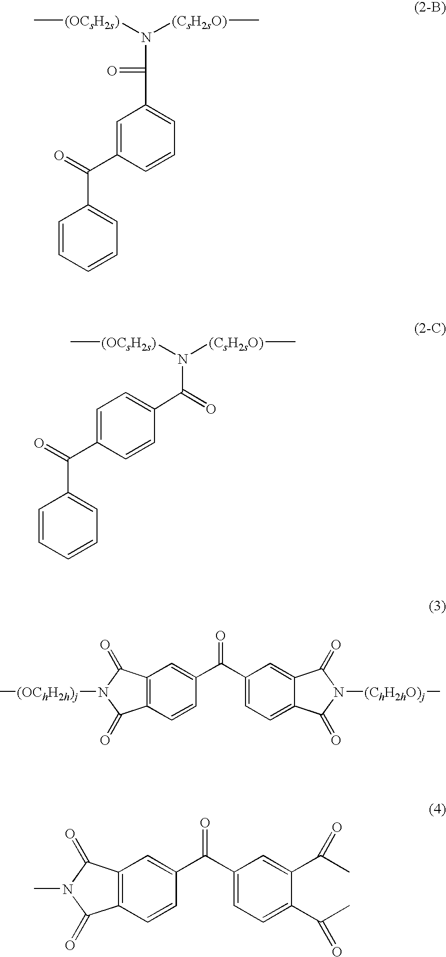

wherein Y, h, j and s have the meaning already indicated above.

Y is a divalent group comprising 1 to 20 atoms selected from C, N, O, S and hydrogen atoms. Any chemically stable divalent groups comprising a combination of one or more of said atoms are meant to be included by said definition, e.g. the groups:

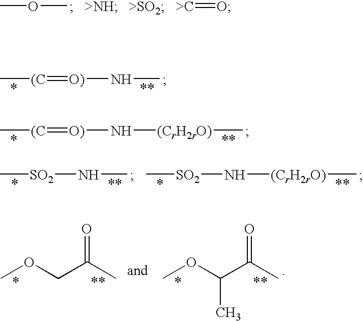

wherein r is an integer from 2 to 4, preferably 2 or 3. More preferred examples of Y include

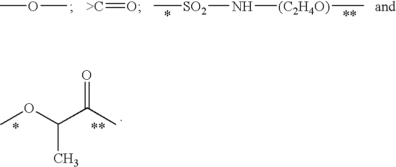

s in formula (2) and (2-A), (2-B) and (2-C) of group X as well as h in formula (3) of group X may independently for each corresponding oxyalkylene moiety be an integer from 2 to 4, are preferably however identical in each moiety. Preferred is a value of 2 or 3 for s and h, in particular 2.

Beside of the aforementioned embodiments of group X of formula (3), said groups X include particularly also those groups wherein j is 0.

Suitable examples of alkyl for the purposes of the present invention are methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetra-methylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl and eicosyl. Where not indicated to the contrary, C₁-C₁₆alkyl, in particular C₄-C₁₆alkyl or C₆-C₁₆alkyl is generally preferred.

Examples of C₁-C₃₀alkyloxy are methoxy, ethoxy, propoxy, isopropoxy, n-butoxy, sec-butoxy, isobutoxy, tert-butoxy, 2-ethylbutoxy, n-pentyloxy, isopentyloxy, 1-methylpentyloxy, 1,3-dimethylbutyloxy, n-hexyloxy, 1-methylhexyloxy, n-heptyloxy, isoheptyloxy, 1,1,3,3-tetra-methylbutyloxy, 1-methylheptyloxy, 3-methylheptyloxy, n-octyloxy, 2-ethylhexyloxy, 1,1,3-trimethylhexyloxy, 1,1,3,3-tetramethylpentyloxy, nonyloxy, decyloxy, undecyloxy, 1-methyl-undecyloxy, dodecyloxy, 1,1,3,3,5,5-hexamethylhexyloxy, tridecyloxy, tetradecyloxy, pentadecyloxy, hexadecyloxy, heptadecyloxy, octadecyloxy and eicosyloxy. C₁-C₂₀alkyloxy is preferred.

Examples of C₂-C₃₀alkenyl are allyl, 2-methallyl, butenyl, pentenyl, hexenyl and oleyl. The carbon atom in position 1 is preferably saturated. C₃-C₁₈alkenyl is particularly preferred.

Examples of C₂-C₃₀alkenyloxy are allyloxy, 2-methallyloxy, butenyloxy, pentenyloxy, hexenyloxy and oleyloxy. C₃-C₁₈alkenyloxy is particularly preferred.

Examples of C₃-C₁₂cycloalkyl unsubstituted or substituted by 1 or more substituents include cyclopentyl, cyclohexyl, cycloheptyl, cyclooctyl, cyclododecyl and 2-methylcyclohexyl. C₅-C₆cycloalkyl unsubstituted or substituted by methyl are preferred.

Examples of C₃-C₁₂cycloalkyloxy unsubstituted or substituted by 1 or more substituents are cyclopentyloxy, cyclohexyloxy, cycloheptyloxy, cyclooctyloxy, cyclododecyloxy and 2-methylcyclohexyloxy. C₅-C₆cycloalkyloxy unsubstituted or substituted by methyl are preferred

Examples of C₅-C₁₂cycloalkenyl unsubstituted or substituted by 1 or more substituents are cyclohexenyl and methylcyclohexenyl.

Examples of C₅-C₁₂cycloalkenyloxy unsubstituted or substituted by 1 or more substituents include cyclohexenyloxy and methylcyclohexenyloxy.

Examples of C₆-C₁₂aryl are phenyl and naphthyl which may optionally be substituted. Unsubstituted or substituted phenyl is preferred.

Examples of substituted phenyl are 4-methylphenyl, 2-ethylphenyl, 4-ethylphenyl, 4-isopropylphenyl, 4-tert-butylphenyl, 4-sec-butylphenyl, 4-isobutylphenyl, 3,5-dimethylphenyl, 3,4-dimethylphenyl, 2,4-dimethylphenyl, 2,6-diethylphenyl, 2-ethyl-6-methylphenyl and 2,6-diisopropylphenyl.

Examples of C₆-C₁₂aryloxy, unsubstituted or substituted by 1 or more substituents, are 4-methylphenyloxy, 2-ethylphenyloxy, 4-ethylphenyloxy, 4-isopropylphenyloxy, 4-tert-butylphenyloxy, 4-sec-butylphenyloxy, 4-isobutylphenyloxy, 3,5-dimethylphenyloxy, 3,4-dimethylphenyloxy, 2,4-dimethylphenyloxy, 2,6-diethylphenyloxy, 2-ethyl-6-methylphenyloxy and 2,6-diisopropylphenyloxy.

Examples of alkylene with up to 34 carbon atoms include ethylene, propylene, trimethylene, tetramethylene, pentamethylene, hexamethylene, octamethylene, decamethylene and dodecamethylene. C₆-C₁₂alkylene is generally preferred.

A preferred meaning of —(C₁-C₁₈alkylene)-NH₂ is -(linear C₂-C₆alkylene)-NH₂ wherein the alkylene group is unsubstituted or substituted by 1 to 3 C₁-C₄alkyl.

Examples for C₆-C₁₂cycloalkylene are cyclopentylene, cycloheptylene and in particular cyclohexylene which may optionally be substituted as defined above.

Examples of C₆-C₁₂arylene are phenylene and naphthylene which may optionally be substituted as defined above. Unsubstituted or substituted phenyl is preferred.

Examples of (C₅-C₁₂cycloalkylene)-(k,k′-C₁-C₄alkylene)-(C₅-C₁₂cycloalkylene) unsubstituted or substituted by 1 or more substituents include methylene-dicyclopentylene, methylen-di(cyclohexylene); 2,2′-propylene-di(cyclohexylene), 2,2′-butylene-di(cyclohexylene) and 2,2′ propylene-di(3-methylcyclohexylene).

Specific examples for —(C₁-C₁₈alkylene)-(C₅-C₇cycloalkylene)-(C₁-C₁₈alkylene)- Include in particular —(C₁-C₁₈alkylene)-(C₅-C₆cycloalkylene)-(C₁-C₁₈alkylene)-, like e.g. the residues of formula:

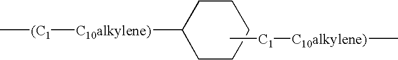

which may be unsubstituted or substituted by 1 or more, in particular by 1 or 2 C₁-C₁₀alkyl groups, e.g. the following group:

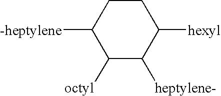

Examples of —(C₆-C₁₂arylene)-(k,k′-C₁-C₄alkylene)-(C₆-C₁₂arylene)- include methylen-di(phenylene); 2,2′-propylene-di(phenylene), 2,2′-butylene-di(phenylene).

Preferred embodiments of —(C₁-C₁₈alkylene)-(C₆-C₁₂arylene)-(C₁-C₁₈alkylene)- are the corresponding phenylene derivatives.

k may be 1 or 2 in the groups -(k,k′-C₁-C₄alkylene)- mentioned above. Examples of -(k,k′-C₁-C₄alkylene)- include for example 1, 1′-methylene; 1,1′-ethylene; 1,1′-propylene; 2,2′-propylene; 1,1′-butylene and 2,2′-butylene. Preferred are 1,1′-methylene and 2,2′-propylene.

Suitable examples of the groups of the formulae:

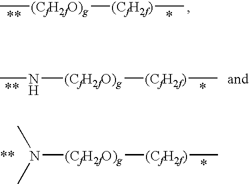

include the groups wherein g is 1, 2, 3 or 4, and f is different or preferably same for each alkylene moiety, and is 2, 3 or 4, in particular 2 or 3 like e.g —C₂H₄OC₂H₄OC₂H₄—; —C₂H₄OC₂H₄OC₂H₄OC₂H₄—; —C₃H₆OC₃H₆OC₃H₆—; —C₃H₆OC₃H₆OC₃H₆OC₃H₆—; —C₂H₄OC₃H₆OC₃H₆OC₃H₆— or —C₂H₄OC₃H₆O—C₂H₄OC₃H₆— or —NHC₂H₄OC₂H₄OC₂H₄—; —NHC₃H₆OC₃H₆OC₃H₆—; —NHC₂H₄OC₂H₄OC₂H₄OC₂H₄—; —NHC₃H₆OC₃H₆OC₃H₆—; —NHC₃H₆OC₃H₆OC₃H₆OC₃H₆—; —NHC₂H₄OC₃H₆O—C₂H₄OC₃H₆— or >NHC₂H₄OC₂H₄OC₂H₄—; >NHC₃H₆OC₃H₆OC₃H₆—; >NHC₂H₄OC₂H₄OC₂H₄OC₂H₄—; >NHC₃H₆OC₃H₆OC₃H₆—; >NHC₃H₆OC₃H₆OC₃H₆OC₃H₆— or >NHC₂H₄OC₃H₆O—C₂H₄OC₃H₆—.

The index m in formula (1) can be 1 or 2. If m is 2, X is a group of formula (4) and R2 is —O—. Preferably however, m is 1.

The compounds of formula (I) are novel, with the exception of the compounds (a) and (b) of formula (II) already mentioned above. A further subject of the present invention are therefore the compounds of formula (I) as described above with the exception of the compounds of formula (II)

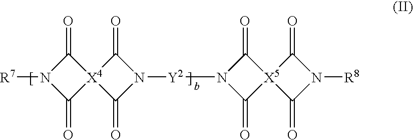

wherein simultaneously
(a) R7 and R8 are C₁₋₈alkyl; X⁴ and X⁵ are -(phenyl)-CO-(phenyl)-, Y² is —CH₂-(phenylene)-CH₂— and b is 1, or
(b) R7 and R8 are 2-ethylhexyl; X⁴ and X⁵ are -(phenyl)-CO-(phenyl)-, Y² is C₁₂alkylene and b is 3.

A specifically mentioned subgroup of these novel compounds of formula (I) are the compounds of formula (I) as defined above, wherein however

R is m+1-valent group selected from:
-G-(C₂-C₃₄alkylene)-G-;
-G-(C₅-C₇cycloalkylene)-G-;
-G-(C₅-C₇cycloalkylene)-(k,k′-C₁-C₄alkylene)-(C₅-C₇cycloalkylene)-G-,
-G-(C₂-C₁₈alkylene)-(C₅-C₇cycloalkylene)-(C₂-C₁₈alkylene)-G-;
-G-(C₆-C₁₂arylene)-G-;
-G-(C₆-C₁₂arylene)-(k,k′-C₁-C₄alkylene)-(C₆-C₁₂arylene)-G-,
-G-(C₂-C₁₈alkylene)-(C₆-C₁₂arylene)-(C₂-C₁₈alkylene)-G-
   wherein said C₂-C₃₄alkylene or C₂-C₁₈alkylene groups can be unsubstituted or substituted by 1 or more substituents selected from Cl; Br; I; OH; NH₂, and C₁-C₄alkoxy, and said C₅-C₇cycloalkylene and C₆-C₁₂arylene groups can be unsubstituted or substituted by 1 or more substituents selected from Cl; Br; I; OH; NH₂, C₁-C₁₀alkyl, C₁-C₁₀alkenyl and C₁-C₁₀alkoxy,
   G is absent or is selected from —O— and >(C═O) and
   k (and k′) is 1 or 2; and
   the groups of the formulae:

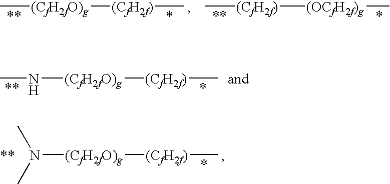

wherein each f is independently for each alkylene moiety of said groups an integer from 2 to 4, and g is from 1 to 10; and
R1 is H; Cl; Br; I; OH; NH₂; a group selected from C₁-C₃₀alkyl, C₂-C₃₀alkenyl, C₁-C₃₀alkyloxy, C₂-C₃₀alkenyloxy, which groups may be unsubstituted or substituted by 1 or more of Cl; Br; I; OH; NH₂, NH(C₁-C₄alkyl), N(C₁-C₄alkyl)₂, COOH; COOC₁-C₄alkyl, C₁-C₄alkoxy; a group selected from C₃-C₁₂cycloalkyl, C₃-C₁₂cycloalkyloxy, C₅-C₁₂cycloalkenyl, C₅-C₁₂cycloalkenyl, C₆-C₁₂aryl, C₆-C₁₂aryloxy, which groups may be unsubstituted or substituted by 1 or more of Cl; Br; I; OH; NH₂, NH(C₁-C₄alkyl), N(C₁-C₄alkyl)₂, COOH; COOC₁-C₄alkyl, C₁-C₄alkyl or C₁-C₄alkoxy, or
R1 is a group —X3-R3-R4, wherein X3 is a group of formula (3) as defined above, and
R3 has one of the meanings of R other than —(C₂-C₈alkylene)- and wherein G is absent; and
R4 is H, NH₂, NH(C₁-C₄alkyl), N(C₁-C₄alkyl)₂, Cl, Br, I, OH, COOH, COOC₁-C₄alkyl.

In another preferred group of compounds of formula (I)

R is specifically selected from
C₂-C₁₂alkylene; -G-(C₂-C₁₂alkylene)-G-;
cyclohexylene; -G-(cyclohexylene)-G-;
-(cyclohexylene)-(k,k′-C₁-C₄alkylene)-(cyclohexylene)-,
-G-(cyclohexylene)-(k,k′-C₁-C₄alkylene)-(cyclohexylene)-G-,
—(C₂-C₁₂alkylene)-(cyclohexylene)-(C₂-C₁₂alkylene)-,
-G-(C₂-C₁₂alkylene)-(cyclohexylene)-(C₂-C₁₂alkylene)-G-;
phenylene; -G-(phenylene)-G-;
   wherein said C₂-C₁₂alkylene groups can be unsubstituted or substituted by 1, 2 or 3 substituents selected from Cl; Br; I; OH; NH₂, and C₁-C₄alkoxy, and said cyclohexylene and phenylene groups can be unsubstituted or substituted by 1, 2 or 3 substituents selected from Cl; Br; I; OH; NH₂, C₁-C₁₀alkyl, and C₁-C₁₀alkoxy;
   G is selected from —O— and >(C═O) and
   k (and k′) is 1 or 2; and
   the groups of the formulae:

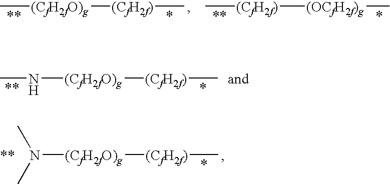

wherein f is 2 or 3 and g is from 1 to 3;
except for the compound of formula (II)

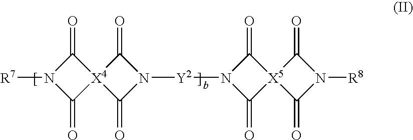

wherein R7 and R8 are 2-ethylhexyl; X⁴ and X⁵ are -(phenyl)-CO-(phenyl)-, Y² is C₁₂alkylene and b is 3.

In still another preferred group of the aforementioned compounds of formula (I)

R1 is selected from:
H; Cl, Br, OH; NH₂; a group selected from C₁-C₄alkyl and C₁-C₄alkoxy, or
R1 is a group —X3-R3-R4, wherein X3 is a group of formula (3) as defined above, and
R3 is —(C₉-C₂₀alkylene)-; and

### R4 is H.

Another specific embodiment of the aforementioned compounds of formula (I) are such compounds, wherein

R2 is selected from H, C₁-C₄alkyl, C₁₀-C₂₀alkyl and C₁-C₄alkyloxy, which groups may be unsubstituted or substituted by 1, 2 or 3 of Cl; Br; I; OH; NH₂ or C₁-C₄alkoxy; or
R2 is a group —R5-R6, wherein
R5 has one of the meanings of R other than —C₂-C₃₄alkylene- and wherein G is absent; and

### R6 is H or NH₂; or

### R2 is —O—.

A further specific group of compounds of formula (I) particularly useful for the purposes of the present invention are the compounds of formula (I), wherein

n is 1 to 7;
X is an m+1-valent group selected from the groups of formula (1-A) and (3-A):

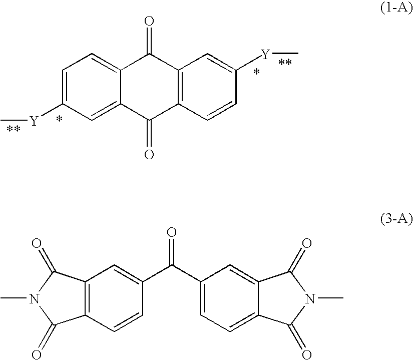

wherein
Y is selected from the groups:

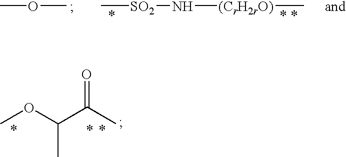

R is a group selected from:
C₆-C₁₂alkylene and -G-(C₆-C₁₂alkylene)-G-;
wherein said C₆-C₁₂alkylene groups can be unsubstituted or substituted by 1, 2 or 3 substituents selected from Cl; Br; I; OH; NH₂, and C₁-C₄alkoxy, and

### G is —O—;

R1 is C₁-C₁₂alkyl or C₁-C₁₂alkyloxy, or, if X is a group of formula (3-A) may also be a group —X3-R3-R4, wherein X3 is a group of formula (3-A),
R3 is C₉-C₂₀alkylene; and

### R4 is H; and

R2 is H or C₆-C₁₂alkyl, unsubstituted or substituted by 1, 2 or 3 substituents selected from Cl; Br; I; OH; NH₂, and C₁-C₄alkoxy.

The compound of the formula (I) preferably corresponds to a compound of the formula (I-a)

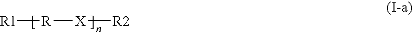

wherein
n is a number from 1 to 10; preferably 1.5 to 8;
X is a group of the formula (1-A), (1-D), (2-A) or (3-A)

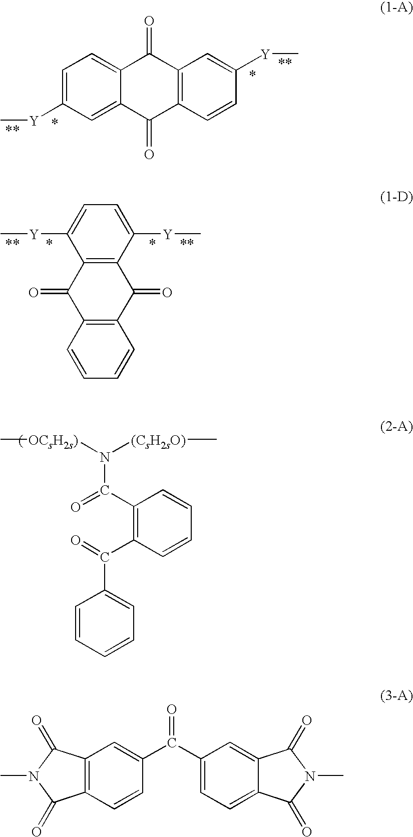

Y is —O— or a group of the formula

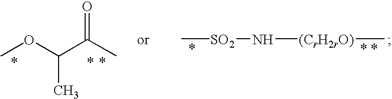

s is 2;
r is 2;
R is C₆-C₁₂alkylene, —O—(C₆-C₁₂alkylene)-O—, —CO-phenylene-CO—, -cyclohexylene-(C₁-C₆alkylene)-cyclohexylene wherein the cyclohexylene groups are unsubstituted or substituted by 1 to 3 C₁-C₄alkyl;
a group

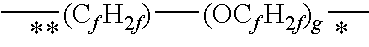

wherein each f is independently for each alkylene moiety of said group an integer from 2 to 4, and g is an integer from 1 to 10; or
a group of the formula

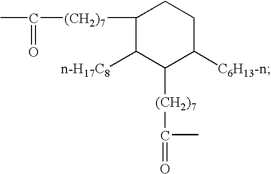

R1 is hydrogen, —Br, —OH, —NH₂, C₁-C₄alkyl or C₁-C₄alkyloxy; and
R2 is hydrogen, C₁-C₁₈alkyl, C₁-C₄alkyloxy;
-cyclohexylene-(C₁-C₆alkylene)-cyclohexylene-NH₂ wherein the cyclohexylene groups are unsubstituted or substituted by 1 to 3 C₁-C₄alkyl;
—(C₁-C₁₈alkylene)-NH₂ or
a group

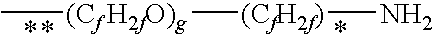

wherein each f is independently for each alkylene moiety of said group an integer from 2 to 4, and g is an integer from 1 to 10.

Particularly preferred examples of the compounds of formula (I) wherein X is a group of formula (1) are the following compounds:

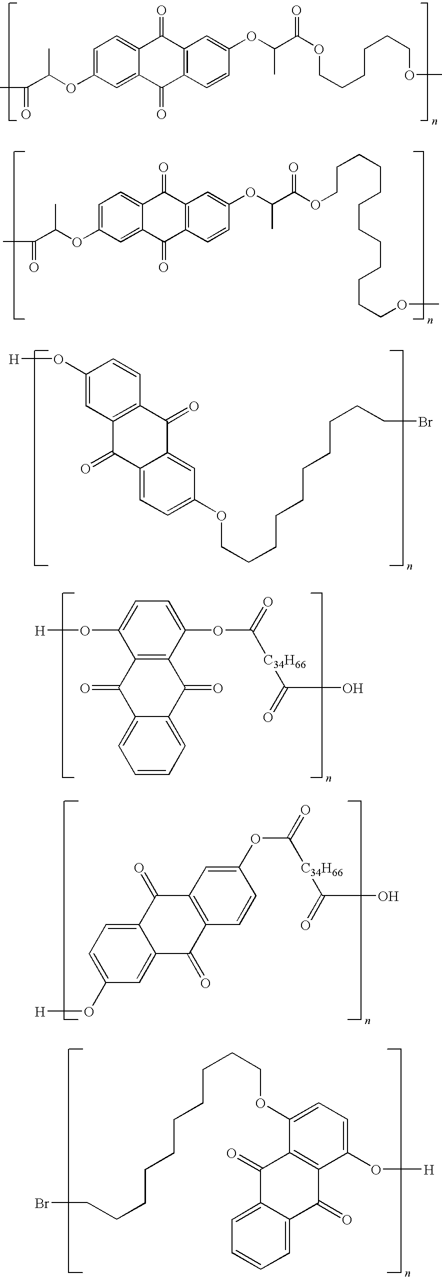

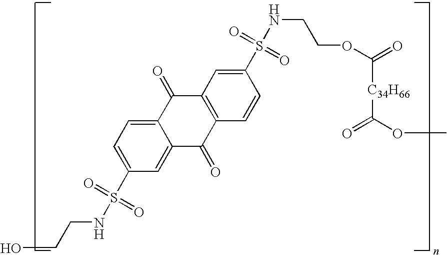

wherein n is as defined above.

Particularly preferred examples of the compounds of formula (I) wherein X is a group of formula (2) are the following compounds:

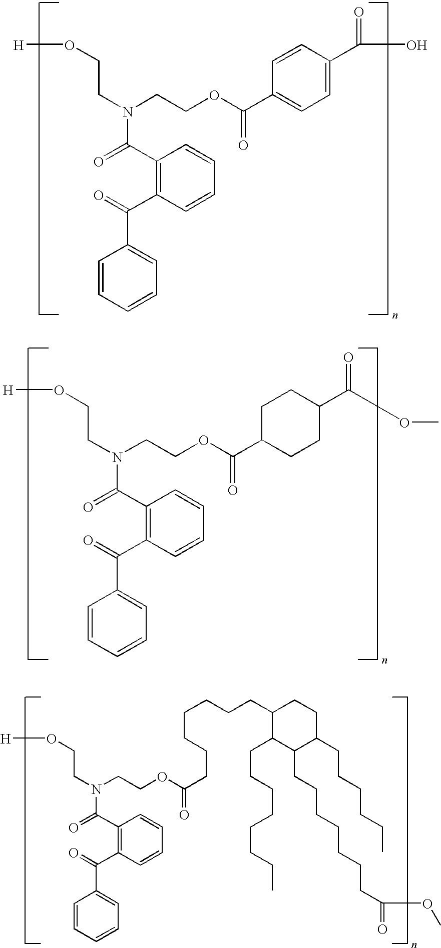

wherein n is as defined above.

Particularly preferred examples of the compounds of formula (I) wherein X is a group of formula (3) or formula (4) are the following compounds:

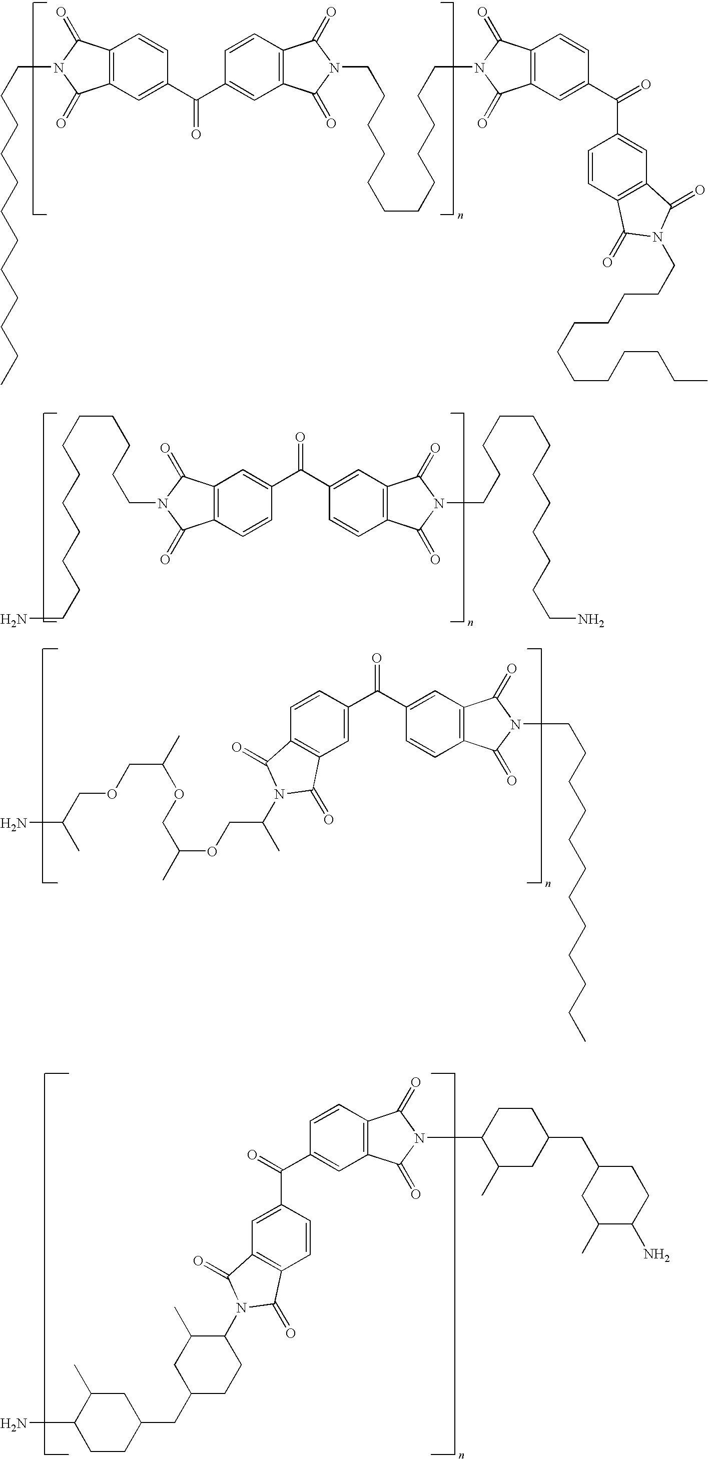

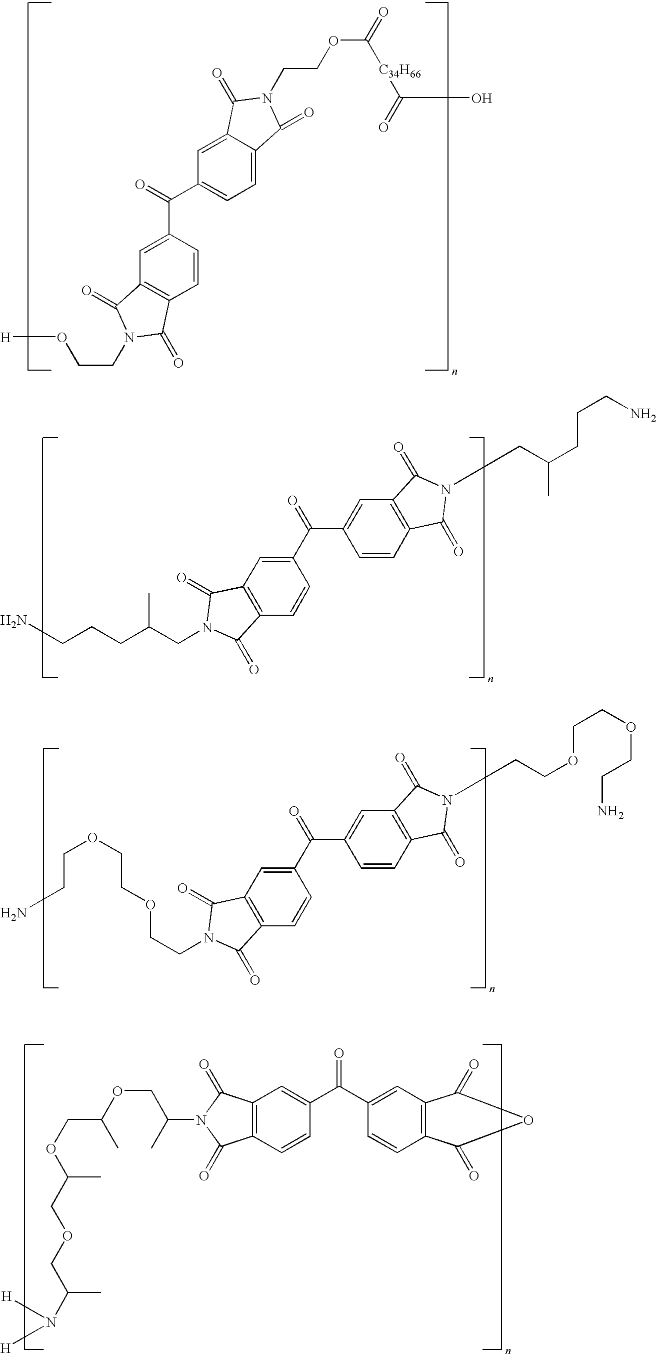

wherein n is as defined above.

In particular, the compound of the following formula:

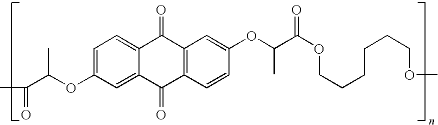

and having a number-average molecular weight (Mn) of about 2740 g/mol and a melting range of 83° to 93° C.; as well as
the compound of the following formula

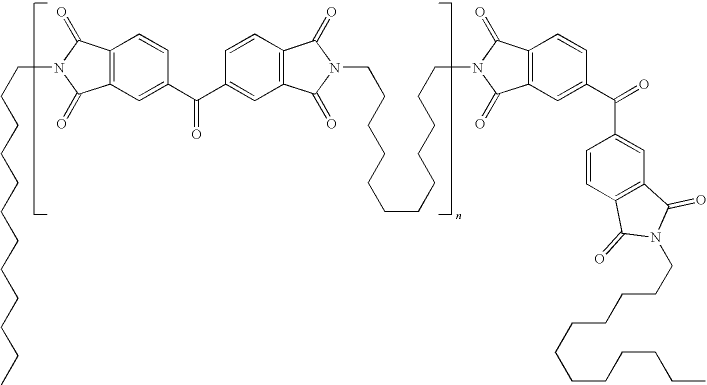

and having a number-average molecular weight (Mn) of about 1040 g/mol and a melting range of 166° to 174° C.
are very suitable for the purposes of the present invention.

The compounds of the formula (I) described above can be prepared according to known processes, preferably in analogy to the methods described in the Examples of the present application. Necessary starting materials can be easily prepared by those skilled in the art, and are in many cases commercially available compounds, like e.g. 2,6-Dihydroxy-anthraquinone; 1,2-Dihydroxy-anthraquinone; 1,5-Dihydroxy-anthraquinone; Benzophenone-3,3′,4,4′-tetracarboxylic dianhydride; 2-Benzoylbenzoic acid; 3-Benzoylbenzoic acid; 4-Benzoylbenzoic acid; Anthraquinone-1-sulfonic acid, Anthraquinone-2-sulfonic acid; Anthraquinone-1,5-disulfonic acid; Anthraquinone-2,6-disulfonic acid or Anthraquinone-2,7-disulfonic acid and their salts, in particular the corresponding sodium salts; or Anthraquinone-2-carboxylic acid, to mention just a few.

Beside the degradation accelerator compound of formula (I) as described above, the polymer articles according to the present invention comprise a natural and/or a synthetic polymer as component (A).

Examples of polymers suitable as component (A) include:

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, Vlb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimids, polyesterimids, polyhydantoins and polybenzimidazoles.

18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.

19. Polycarbonates and polyester carbonates.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acrylates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

Component (A) is preferably a thermoplastic synthetic polymer. Preferred examples are

a) Homo and copolymers of olefin monomers such as ethylene and propylene, but also higher 1-olefins such as 1-butene, 1-pentene, 1-hexene or 1-octen. Preferred is polyethylene LDPE and LLDPE, HDPE and polypropylene.
b) Homo- and copolymers of olefin monomers with diolefin monomers such as butadiene, isoprene and cyclic olefins such as norbornene.
c) Copolymers of one or more 1-olefins and/or diolefins with carbon monoxide and/or with other vinyl monomers, including, but not limited to, acrylic acid and its corresponding acrylic esters, methacrylic acid and its corresponding esters, vinyl acetate, vinyl ketone, styrene, maleic acid anhydride and vinyl chloride.
d) Polyvinyl alcohol
e) Other thermoplastics such as poly(meth)acrylate esters, polystyrene, styrene-acrylonitrile copolymer, acrylonitrile-butadiene-styrene copolymer, polyvinyl chloride, polyvinylidene chloride, polyvinyl acetate, polyvinylbutyral, ethylene-vinyl alcohol copolymer, polyethylene terephthalate (PET), polybutylene terephthalate (PBT), liquid crystal polyesters (LCPs), polyacetals (e.g., POM), polyamides (PA), polycarbonates, polyurethane and polyphenylene sulfide (PPS); polymer blends or polymer alloys formed of two or more of these resins; and compounds obtained by adding fillers such as glass fibers, carbon fibers, semi-carbonized fibers, cellulose fibers and glass beads, flame retardants, blowing agents, antimicrobial agents, crosslinking agents, fine polyolefin resin powder, polyolefin waxes, ethylene bisamide waxes, metallic soaps and the like either singly or in combination to these resins. Examples of thermosetting resins, on the other hand, can include thermosetting resins such as epoxy resins, melamine resins and unsaturated polyester resins; and compounds obtained by incorporating fillers such as glass fibers, carbon fibers, semi-carbonized fibers, cellulose fibers and glass beads, flame retardants and the like either singly or in combination to these resins.

Further preferred examples of component (A) are biologically degradable polymers like in particular polyethylensuccinate, polybutylensuccinate, polybutylensuccinate/adipate, polybutylensuccinate/carbonate, polybutylensuccinate/terephtalate, polycaprolactone, poly(hydroxyalcanoates), poly 3-hydroxybutyrate, polylactic acid, polyester amides, or blends of these materials with natural or modified starch, polysaccarides, lignin, wood flour, cellulose and chitin.

According to a particular preferred embodiment of the present invention component (A) is a polyolefin homo- or copolymer, a polyester homo- or copolymer, a polyamide homo- or copolymer, blends thereof, a starch modified polyolefin or a starch based polymer composite.

According to a further preferred embodiment of the present invention component (A) is polyethylene, polypropylene, a polyethylene copolymer or a polypropylene copolymer.

According to a particular embodiment, the composition additionally contains a component (C) which is an inorganic or organic salt of a transition metal.

Component (C) is preferably a metal salt of a fatty acid with a carbon number ranging from C₂ to C₃₆, in particular from C₁₂ to C₃₆. Particularly preferred examples are metal carboxylates of palmitic acid (C₁₆), stearic acid (C₁₈), oleic acid (C₁₈), linoleic acid (C₁₈) and linolenic acid (C₁₈). Further examples of component (C) are aromatic acids, e.g. benzoic acid. Component (C) as C₂-C₃₆-carboxylate of Fe, Ce, Co, Mn, Cu or V such as a C₁₂-C₂₀alkanoate or a C₁₂-C₂₀alkenoate is of particular interest.

Further examples of component (C) include manganese titanate, manganese borate*), manganese potassium sulfate*), manganese pyrophosphate*), manganese sulfamate*), manganese ferrite, manganese(II) tetraborate, containing calcium carbonate, manganese dioxide, manganese sulfate*), manganese nitrate*), manganese chloride*), and manganese phosphate*). The salts indicated by *) may be used in hydrated or non-hydrated form.

Furthermore, a composition useful for making plastic articles according to the present invention may additionally contain one or more conventional additives which are either commercially available or can be prepared according to known methods.

Examples or such additives include:

### 1. Antioxidants

Antioxidants may be present in amounts to stabilize the polymer during processing and forming steps of the plastic article. Large quantities are however undesired in order to not prevent degradation of the polymer article. Suitable examples of antioxidants include:

1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2, 2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)-disulfide.

1.6. Alkylidenebisphenols, for example 2, 2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra-(5-tert-butyl-4-hydroxy-2-methylphenyl)pentane.

1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1,3,5-tris(3,5-dicyclohexyl-4-hydroxybenzyl)iso-cyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.

1.15. Esters of 6-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of 6-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

### 2. UV Absorbers and Light Stabilizers

2.1. 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

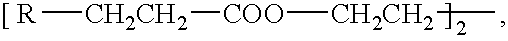

where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]-benzotriazole; 2-[2′-hydroxy-3′-(1,1,3,3-tetramethylbutyl)-5′-(α,α-dimethylbenzyl)-phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(β-carbomethoxy-β-cyanovinyl)-2-methylindoline, neopentyl tetra(α-cyano-β,β-diphenylacrylate.

2.5. Nickel compounds, for example nickel complexes of 2,2′-thio-bis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyphexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydrooxy-2-methylpropoxy)-4-octadecanoyloxy-2,2,6,6-tetramethylpiperidine, 5-(2-ethylhexanoyl)-oxymethyl-3,3,5-trimethyl-2-morpholinone, Sanduvor (Clariant; CAS Reg. No. 106917-31-1], 5-(2-ethylhexanoyl)oxymethyl-3,3,5-trimethyl-2-morpholinone, the reaction product of 2,4-bis-[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)-amino)-s-triazine.

2.7. Oxamides, for example 4, 4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydrooxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.
4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

The following phosphites are especially preferred:

Tris(2,4-di-tert-butylphenyl) phosphite (Irgafos® 168, Ciba Specialty Chemicals Inc.), tris(nonylphenyl) phosphite,

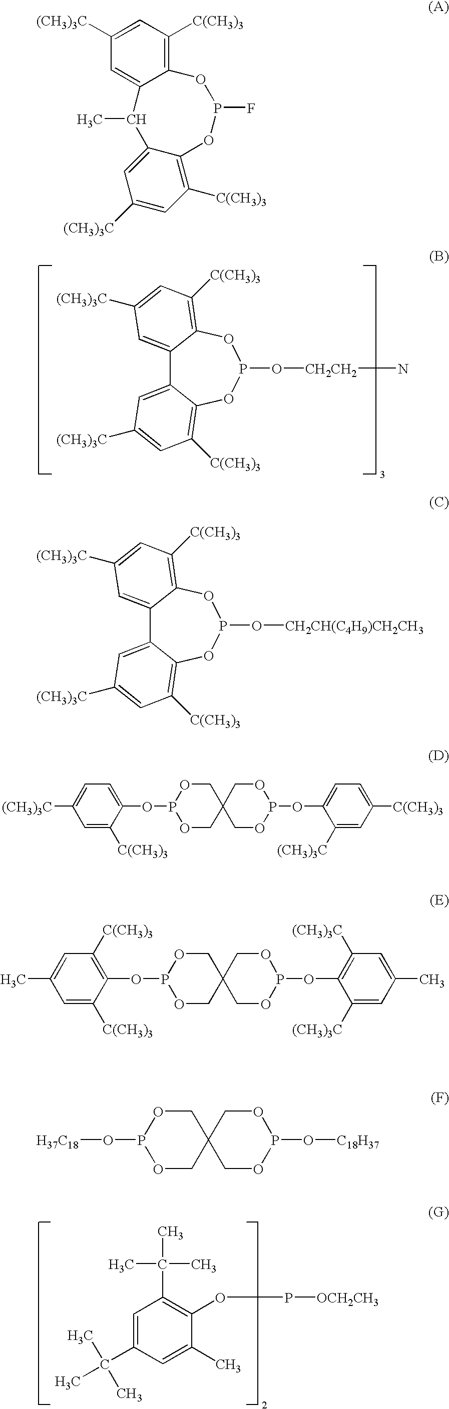

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.
6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.
7. Thiosynergists, for example dilauryl thiodipropionate, dimistryl thiodipropionate, distearyl thiodipropionate or distearyl disulfide.
8. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.
9. Polyamide stabilizers, for example copper salts in combination with iodides and/or phosphorus compounds and salts of divalent manganese.
10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.
11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyldibenzylidene)sorbitol, and 1,3:2,4-di(benzylidene)sorbitol.
12. Fillers and reinforcing agents, for example calcium carbonate, silicates, glass fibres, glass beads, asbestos, talc, kaolin, mica, barium sulfate, metal oxides and hydroxides, carbon black, graphite, wood flour and flours or fibers of other natural products, synthetic fibers.
13. Other additives, for example plasticisers, lubricants, emulsifiers, pigments, rheology additives, catalysts, flow-control agents, optical brighteners, flameproofing agents, antistatic agents and blowing agents.
14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-di-methylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctylbenzofuran-2-one.

According to a preferred embodiment, the composition contains one or more of the following components
(D-I) a filler or reinforcing agent,
(D-II) a pigment,
(D-III) a light stabilizer,
(D-IV) a processing additive,
(D-V) an antioxidant,
(D-VI) an inorganic or organic salt of Ca, Mg, Zn or Al, or an oxide of Ca, Mg, Zn or Al,
(D-VII) a terpene derivative, an anthraquinone derivative and/or a benzophenone derivative,
(D-VIII) an inorganic oxidant.

Component (D-I) covers e.g. calcium carbonate, silicas, glass fibres, glass bulbs, talc, kaolin, mica, barium sulfate, metal oxides and hydroxides, carbon black, graphite, wood flour, flours of other natural products, synthetic fibers and metal stearates used as fillers such as calcium stearate or zinc stearate; unsaturated organic polymers such as polybutadiene, polyisoprene, polyoctenamer, or unsaturated acids such as stearic acid, oleic acid, linoleic acid or linolenic acid; and further polymers such as polyethylene oxide or polypropylene oxide.

Component (D-II) is for example carbon black, titanium dioxide (anatase or rutile which may range in particle size from e.g. 1000 μm to 10 nm and which may optionally be surface treated) or another organic or inorganic colour pigment frequently used in agricultural applications (for example carbon black, brown, silver, red, green).

Component (D-III) is preferably a hindered amine light stabilizer (HALS) or an UV absorber. Examples are disclosed in the above list of additives under item 2. Examples of preferred hindered amine light stabilizers are also those compounds which are disclosed for example as components (A), (B) and (C) in WO-A-01/92,392 which is incorporated by reference herein and which is equivalent to U.S. patent application Ser. No. 10/257,339.

Component (D-IV) is for example an antislip/antiblock additive, a plasticizer, an optical brightener, an antistatic agent or a blowing agent.

Component (D-V) is for example one of the antioxidants listed in the above additives list under item 1. A phenolic antioxidant is preferred.

Component (D-VI) is for example a metal stearate, e.g. calcium stearate or zinc stearate; or zinc oxide (which may range in particle size from e.g. 1000 μm to 10 nm and which may optionally be surface treated).

Component (D-VII) is for example a polyterpene resin of natural or synthetic origin. The polyterpenes are either commercially available or can be prepared according to known methods.

The polyterpene resins are for example based on acyclic terpenes or cyclic terpenes, e.g. monocyclic terpenes or bicyclic terpenes. Polyterpenes based on terpene hydrocarbons are preferred.

Examples of acyclic terpenes are
terpene hydrocarbons, e.g.
myrcene, ocimene and beta-farnesene;
terpene alcohols, e.g.
dihydromyrcenol (2,6-dimethyl-7-octen-2-ol), geraniol (3,7-dimethyl-trans-2,6-octadien-1-01), nerol (3,7-dimethyl-cis-2,6-octadien-1-ol), linalool (3,7-dimethyl-1,6-octadien-3-ol), myrcenol (2-methyl-6-methylene-7-octen-2-ol), lavandulol, citronellol (3,7-dimethyl-6-octen-1-ol), trans-trans-farnesol (3,7,11-trimethyl-2,6,10-dodecatrien-14) and trans-nerolidol (3,7,11-trimethyl-1,6,10-dodecatrien-34);
terpene aldehydes and acetals, e.g.
citral (3,7-dimethyl-2,6-octadien-1-al), citral diethyl acetal (3,7-dimethyl-2,6-octadien-1-aldiethyl acetal), citronellal (3,7-dimethyl-6-octen-1-al), citronellyloxyacetaldehyde and 2,6,10-trimethyl-9-undecenal;
terpene ketones, e.g.
tagetone, solanone and geranylacetone (6,10-dimethyl-5,9-undecadien-2-one);
terpene acids and esters, e.g.
cis-geranic acid, citronellic acid, geranyl esters (including geranyl formate, geranyl acetate, geranyl propionate, geranyl isobutyrate and geranyl isovalerate), neryl esters (including neryl acetate), linalyl esters (including linalyl formate, linalyl acetate, linalyl propionate, linalyl butyrate and linalyl isobutyrate), lavandulyl esters (including lavandulyl acetate), citronellyl esters (including citronellyl formate, citronellyl acetate, cintronellyl propionate, citronellyl isobutyrate, citronellyl isovalerate and citronellyl tiglate); and
nitrogen containing unsaturated terpene derivatives, e.g.
cis-geranic acid nitrile and citronellic acid nitrile.

Examples of cyclic terpenes are
cyclic terpene hydrocarbons, e.g.
limonene (1,8-p-methadiene), alpha-terpinene, gamma-terpinene (1,4-p-menthadiene), terpinolene, alpha-phellandrene (1,5-p-menthadiene), beta-phellandrene, alpha-pinene (2-pinene), beta-pinene (2(10)-pinene), camphene, 3-carene, caryophyllene, (+)-valencene, thujopsene, alpha-cedrene, beta-cedrene and longifolene;
cyclic terpene alcohols and ethers, e.g.
(+)-neoiso-isopulegol, isopulegol (8-p-menten-3-ol), alpha-terpineol (1-p-menten-8-ol), beta-terpineol, gamma-terpineol, delta-terpineol and 1-terpinen-4-ol (1-p-menten-4-ol);
cyclic terpene aldehydes and ketones, e.g.
carvone (1,8-p-mantadien-6-one), alpha-ionone (C₁₃H₂₀O), beta-ionone (C₁₃H₂₀O), gamma-ionone (C₁₃H₂₀O), irone (alpha-, beta-, gamma-) (C₁₄H₂₂O), n-methylionone (alpha-, beta-, gamma-) (C₁₄H₂₂O), isomethylionone (alpha-, beta-, gamma-) (C₁₄H₂₂O), allylionone (C₁₆H₂₄O), pseudoionone, n-methylpseudoionone, isomethylpseudoionone, damascones (1-(2,6,6-trimethylcycohexenyl)-2-buten-1-ones; including beta-damascenone (1-(2,6,6-trimethyl-1,3-cyclohadienyl)-2-buten-1-one)), nootkatone (5,6-dimethyl-8-isopropenylbicyclo[4.4.0]-1-decen-3-one) and cedryl methyl ketone (C₁₇H₂₆O); and
cyclic terpene esters, e.g.
alpha-terpinyl acetate (1-p-menthen-8-yl acetate), nopyl acetate ((−)-2-(6,6-dimethylbicyclo[3.1.1]hept-2-en-2-yl)ethyl acetate) and khusymil acetate.

Further suitable terpene derivatives can be found in Kirk-Othmer, Encyclopedia of Chemical Technology, John Wiley & Sons, 4. ed. (1994), Vol. 23, p. 833-882.

Preferred examples of terpenes which can serve as the basis for the polyterpenes are tricyclene, alpha-pinene, alpha-fenchene, camphene, beta-pinene, myrcene, cis-pinane, cis/trans-p-8-menthene, trans-2-p-menthene, p-3-menthene, trans-p-menthane, 3-carene, cis-p-menthane, 1,4-cineole, 1,8-cineole, alpha-terpinene, p-1-menthene, p-4(8)-menthene, limonene, p-cymene, gamma-terpinene, p-3,8-menthadiene, p-2,4(8)-menthadiene and terpinolene.

Further examples of component (D-VII) are cycloaliphatic compounds structurally related to terpenes such as the following
alcohols, e.g.
5-(2,2,3-trimethyl-3-cyclopenten-1-yl)-3-methylpentan-2-ol;
aldehydes, e.g.
2,4-dimethyl-3-cyclohexene carboxaldehyde, 4-(4-methyl-3-penten-1-yl)-3-cyclohexene carboxaldehyde and 4-(4-hydroxy-4-methylpentyl)-3-cyclohexene carboxaldehyde;
ketones, e.g.
civetone, dihydrojasmone (3-methyl-2-pentyl-2-cyclopenten-1-one), cis-jasmone (3-methyl-2-(2-cis-penten-1-yl)-2-cyclopenten-1-one), 5-cyclohexadecen-1-one, 2,3,8,8-tetramethyl-1,2,3,4,5,6,7,8-octahydro-2-napthalenyl methyl ketone and 3-methyl-2-cyclopenten-2-ol-1-one; and
esters, e.g.
4,7-methano-3a,4,5,6,7,7a-hexahydro-5-(or 6)-indenyl acetate, allyl 3-cyclohexylpropionate, methyl dihydrojasmonate methyl (3-oxo-2-pentylcyclopentyl)acetate.

The polyterpenes used in the present invention may also be derived from the copolymerisation of the aforementioned terpenes with other unsaturated organic compounds.

Other examples of component (D-VII) are the unsaturated coal-tar by-product polymers such as cumarone-indene resins, rosin and the like.

Present component (D-VII) is preferably a polyterpene resin selected from the group consisting of poly-alpha-pinene, poly-beta-pinene, polylimonene or a copolymer of alpha-pinene, a copolymer of beta-pinene or a copolymer of limonene. Poly-beta-pinene is particularly preferred.

Terpene-based hydrocarbon resins are typically based on products such as alpha-pinene, beta-pinene and d-limonene, which are obtained from the wood and citrus industry, respectively. Terpene-based resins have been available since the mid-1930s (Kirk-Othmer, Encyclopedia of Chemical Technology, John Wiley & Sons, 4. ed. (1994), Vol. 13, p. 717-718). Polymerization of monoterpenes is most commonly accomplished by carbocationic polymerization utilizing Friedel-Crafts-type catalyst systems, such as aluminum chloride (Kirk-Othmer, Encyclopedia of Chemical Technology, John Wiley & Sons, 4. ed. (1994), Vol. 1, p. 459).

In general, the polyterpenes of component (D-VII) have more than one terpene unit. They have preferably a molecular weight of about 400 g/mol to about 1400 g/mol.

Component (D-VIII) is in particular an inorganic peroxide or an inorganic superoxide, in particular of an alkali metal or an alkaline earth metal, or of a transition metal. Suitable examples of component (D-VIII) as a peroxide are magnesium peroxide (MgO₂), calcium peroxide (CaO₂), strontium peroxide (SrO₂), barium peroxide (BaO₂), lithium peroxide (Li₂O₂), sodium peroxide (Na₂O₂), potassium peroxide (K₂O₂), zinc peroxide (ZnO₂), silver peroxide (Ag₂O₂), copper peroxide or iron peroxide. Suitable examples of component (D-VIII) as a superoxide are lithium superoxide (LiO₂), sodium superoxide (NaO₂), potassium superoxide (KO₂), rubidium superoxide (RbO₂) and cesium superoxide (CsO₂). Preferred are lithium peroxide, sodium peroxide, magnesium peroxide, calcium peroxide, barium peroxide, zinc peroxide and potassium superoxide. Particularly preferred are sodium peroxide, magnesium peroxide, calcium peroxide and zinc peroxide. A comprehensive summary of inorganic peroxides or superoxides, which are useful for the present invention, is given in Kirk-Othmer, Encyclopedia of Chemical Technology, John Wiley & Sons, 4. ed. (1994), Vol. 18, pages 202-229, which is incorporated by reference herein. Blends of the abovementioned peroxides and/or superoxides can also be used.

Component (D-VIII) is preferably an inorganic peroxide of an alkali metal, an alkaline earth metal or a transition metal, or an inorganic superoxide of an alkali metal, an alkaline earth metal or a transition metal.

Further preferred examples of component (D-VIII) are magnesium peroxide, calcium peroxide, strontium peroxide, barium peroxide, lithium peroxide, sodium peroxide, potassium peroxide, zinc peroxide, silver peroxide, copper peroxide, iron peroxide, lithium superoxide, sodium superoxide, potassium superoxide, rubidium superoxide and cesium superoxide; in particular sodium peroxide, magnesium peroxide, calcium peroxide and zinc peroxide; especially calcium peroxide.

Component (D-VIII) is conveniently a compound which—when in contact with humidity—reacts with water in order to liberate an active auxiliary prodegradant species, and which is thermoprocessable in a temperature range between 100° and 300° C.

The polymer article according to the present invention can be any type of plastic article which needs an enhanced degradation in natural sunlight and/or humidity at low, ambient or elevated temperature.

For example, suitable polymer articles are plastic films, sheets, bags, bottles, styrofoam cups, plates, utensils, blister packages, boxes, package wrappings, plastic fibers, tapes, agricultural articles such as twine agricultural films, mulch films, small tunnel films, banana bags, direct covers, nonwoven, pots for agricultural use, goetextiles, landfill covers, industrial covers, waste covers, temporary scaffolding sheets, building films, silt fences, poultry curtains, films for building temporary shelter constructions, disposable diapers, disposable garments, and the like.

According to a preferred embodiment, the polymer article is an agricultural article which is for example selected from the group consisting of mulch films, row covers, small tunnel films, banana bags, direct covers, nonwoven, twines and pots.

A polymer article which is a monolayer or three-layers mulch film having a thickness of 5 to 100 microns is particularly preferred.

A polymer article which is a monolayer or three-layers mulch film having a thickness of 5 to 100 microns and being partly buried with soil is also preferred.

According to another preferred embodiment, the polymer article is a packaging material and/or which is used for consumer products (e.g. supermarket bags or refuse sacks).

The packaging material is in particular for food, beverage or cosmetics.

According to a further preferred embodiment, the polymer article is a hygienic or medical article.

Preferred is also a polymer article which is selected from the group consisting of films, fibers, profiles, bottles, tanks, containers, sheets, bags, styrofoam cups, plates, blister packages, boxes, package wrappings and tapes.

When the polymer article according to the present invention is useful for the construction area, it may be for example a geomembrane, a geotextile, a geogrid or a scaffolding film.

The polymer articles may be manufactured by any process available to those of ordinary skill in the art including, but not limited to, extrusion, extrusion blowing, film casting, film blowing, calendering, injection molding, blow molding, compression molding, thermoforming, spinning, blow extrusion and rotational casting.

A polymer article which is shaped by injection molding, blow molding, compression molding, roto molding, slush molding, extrusion, film casting, film blowing, calendering, thermoforming, spinning or rotational casting is particularly preferred.

The rate of the degradation of the polymer component (A) can simply be adjusted by changing the concentration of component (B), the degradation accelerator, i.e. if slower degradation is desired, less of component (B) is added. Component (B) is preferably present in the composition which forms the polymer article in an amount of 0.01 to 10%, preferably 0.01 to 5%, relative to the weight of component (A).

Component (C) is preferably present in the composition which forms the polymer article in an amount of 0.001 to 10%, preferably 0.005 to 5%, relative to the weight of component (A).

Component (D-I) is preferably present in the composition which forms the polymer article in an amount of 0.05 to 80%, preferably 0.5 to 70%, relative to the weight of component (A).

Component (D-II) is preferably present in the composition which forms the polymer article in an amount of 0.05 to 40%, preferably 0.05 to 30%, relative to the weight of component (A).

Component (D-III) is preferably present in the composition which forms the polymer article in an amount of 0.01 to 20%, preferably 0.01 to 10%, relative to the weight of component (A).

Component (D-IV) is preferably present in the composition which forms the polymer article in an amount of 0.05 to 10%, preferably 0.05 to 5%, relative to the weight of component (A).

Component (D-V) is preferably present in the composition which forms the polymer article in an amount of 0.005 to 1%, preferably 0.01 to 0.3%, relative to the weight of component (A).

Component (D-VI) is preferably present in the composition which forms the polymer article in an amount of 0.005 to 5%, preferably 0.05 to 1%, relative to the weight of component (A).

Component (D-VII) is preferably present in the composition which forms the polymer article in an amount of 0.01 to 10%, preferably 0.01 to 5%, relative to the weight of component (A).

Component (D-VIII) is preferably present in the composition which forms the polymer article in an amount of 0.005 to 20%, preferably 0.1 to 15%, relative to the weight of component (A).

The compounds of the following Examples 1 and 3 are particularly preferred.

### EXAMPLES

The following examples illustrate the invention. All parts or percentages, in the examples as in the remainder of the description and in the claims, are by weight, unless stated otherwise. Room temperature denotes a temperature in the range 20-30° C., unless stated otherwise. Data given for elemental analysis are in % by weight calculated (cal) or experimentally measured (exp) for the elements C, H and N. In the examples, the following abbreviations are used:
PP polypropylene;
LDPE low density polyethylene;
LLDPE linear low density polyethylene;
NMR nuclear magnetic resonance (of ¹H, if not otherwise indicated);
Mn number average of molecular mass (g/mol) as determined by GPC;
GPC gel permeation chromatography;

In the examples, the molecular weight (Mn) of the individual compounds is determined by Gel Permeation Chromatography (GPC). The GPC measurements are carried out on a Perkin Elmer LC 50 liquid chromatograph equipped with a reflective index Perkin Elmer LC 30 and the data are calculated by using a Perkin Elmer software (TurboSEC). All GPC measurements are carried out by using 0.02 M diethanolamine solution in chromatographic grade tetrahydrofuran (THF) as a solvent at 45° C. on PLGEL (Polymer Laboratories) 300 mm×7.5 mm columns with PLgel 3 μm MIXED-E as a stationary phase. Polystyrene standards are used for the calibration curve. Visual melting points and melting ranges are measured by using a Gallenkamp equipment.

“Dimer Acid Hydrogenated” is an isomer mixture whose major compound is

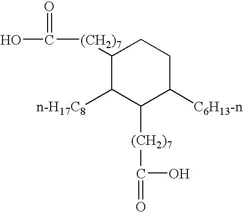

(CAS 68783-41-5; isomer mixture; e.g. available from Aldrich)

“Dimer Acid Hydrogenated” dimethyl ester is obtained from “Dimer Acid Hydrogenated” by esterification reaction conditions known to people skilled in the art. The major compound of the dimethylester is

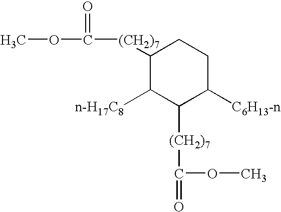

### Synthesis Examples

### Product (1-a)

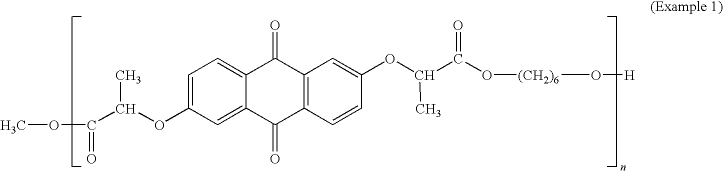

with n being 6.1 based on the number average molecular weight.

### Product (1-b)

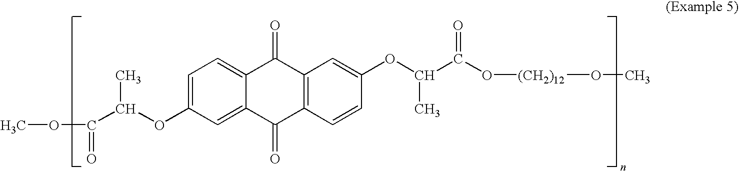

with n being 7.3 based on the number average molecular weight.

### Product (1-c)

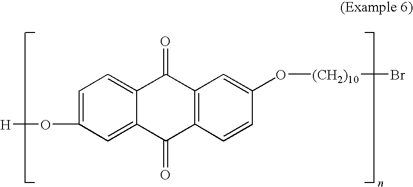

### Product (1-d)

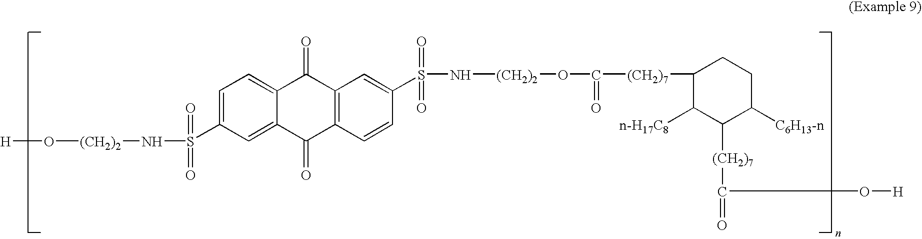

with n being 3.1 based on the number average molecular weight.

### Product (1-e)

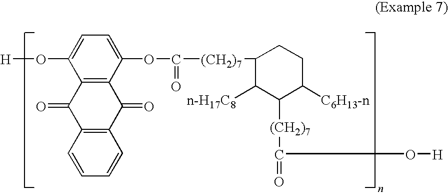

with n being 2.3 based on the number average molecular weight.

### Product (1-f)

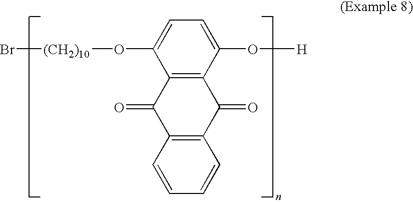

### Product (2-a)

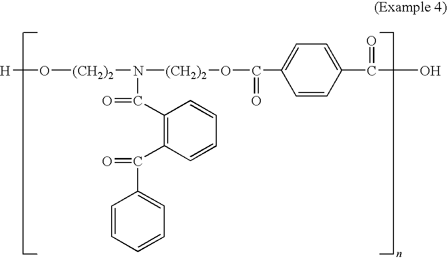

with n being 2.5 based on the number average molecular weight.

### Product (2-b)

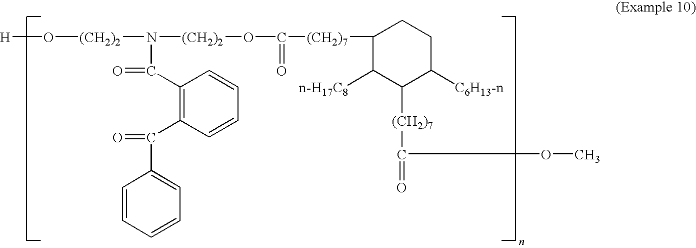

with n being 3.2 based on the number average molecular weight.

### Product (3-a)

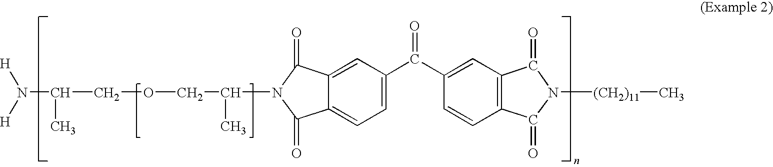

with n being 1.58 based on the number average molecular weight.

### Product (3-b)

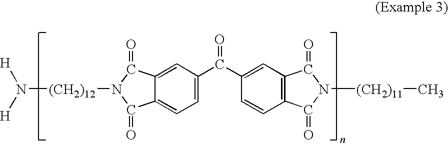

with n being 1.75 based on the number average molecular weight.

### Product (3-c)

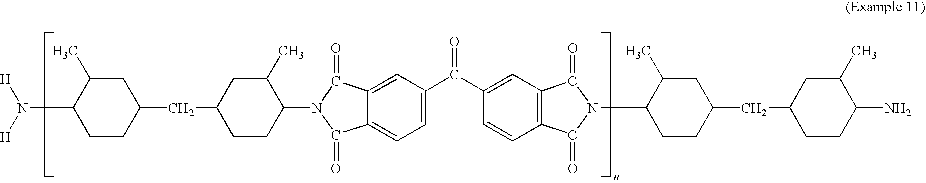

### Product (3-d)

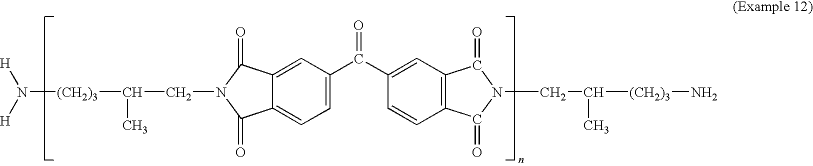

### Product (3-e)

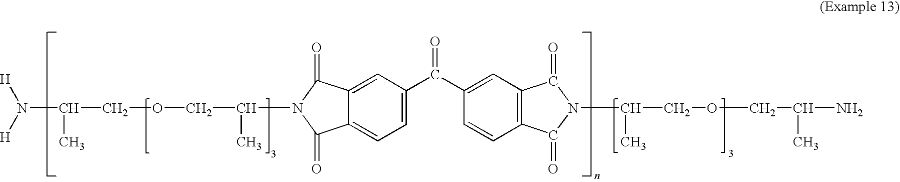

with n being 3.1 based on the number average molecular weight.

### Synthesis Examples of the Compounds of the Formula (I)

| Product | Example | R1 | R | X | R2 | m | n |
|---|---|---|---|---|---|---|---|
| (1-a) | 1 | H— | —O—(CH₂)₆—O— | 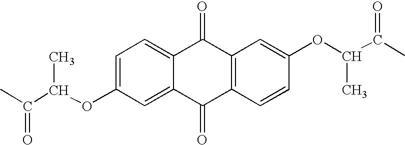 | —OCH₃ | 1 | 6.1 |
| (1-b) | 5 | H₃C— | —O—(CH₂)₁₂—O— | 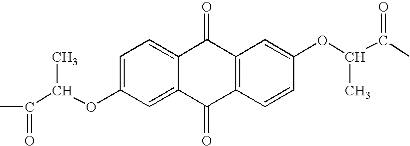 | —OCH₃ | 1 | 7.3 |
| (1-c) | 6 | Br— | —(CH₂)₁₀— | 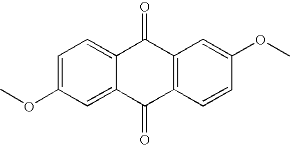 | —H | 1 | *) |
| (1-d) | 9 | HO— | 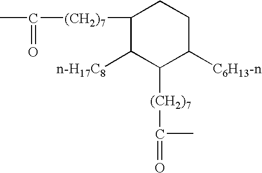 | 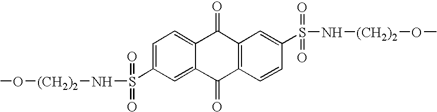 | —H | 1 | 3.1 |
| (1-e) | 7 | HO— | 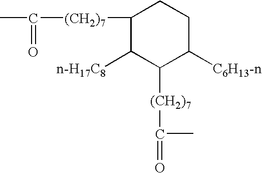 | 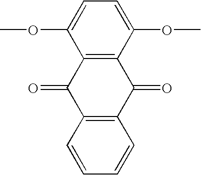 | —H | 1 | 2.3 |
| (1-f) | 8 | Br— | —(CH₂)₁₀— | 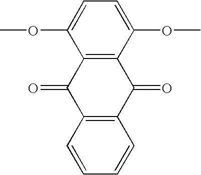 | —H | 1 | *) |
| (2-a) | 4 | HO— | 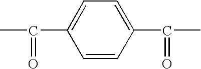 | 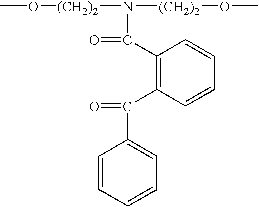 | —H | 1 | 2.5 |
| (2-b) | 10 | H₃CO— | 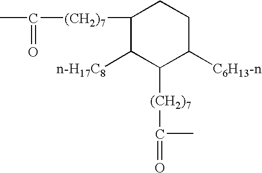 | 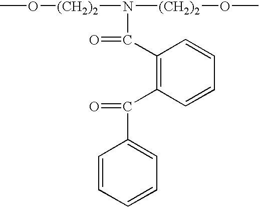 | —H | 1 | 3.2 |
| (3-a) | 2 | H₂N— | 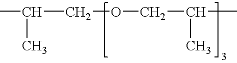 | 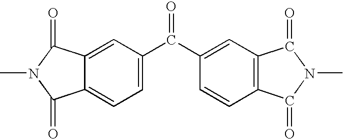 | —(CH₂)₁₁—CH₃ | 1 | 1.58 |
| (3-b) | 3 | H₂N— | —(CH₂)₁₂— | 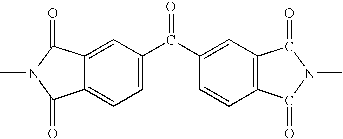 | —(CH₂)₁₁—CH₃ | 1 | 1.75 |
| (3-c) | 11 | H₂N— | 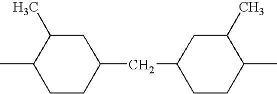 | 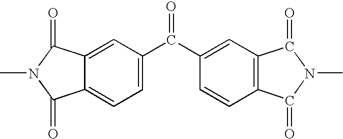 | 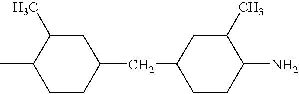 | 1 | *) |
| (3-d) | 12 | H₂N— | 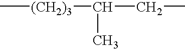 | 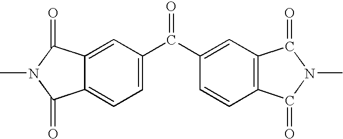 | 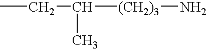 | 1 | *) |
| (3-e) | 13 | H₂N— | 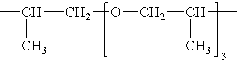 | 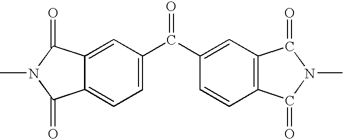 | 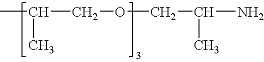 | 1 | 3.1 |

*) not determined.

### Example 1

### Synthesis of

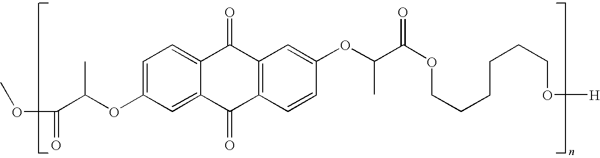

### Synthetic Steps:

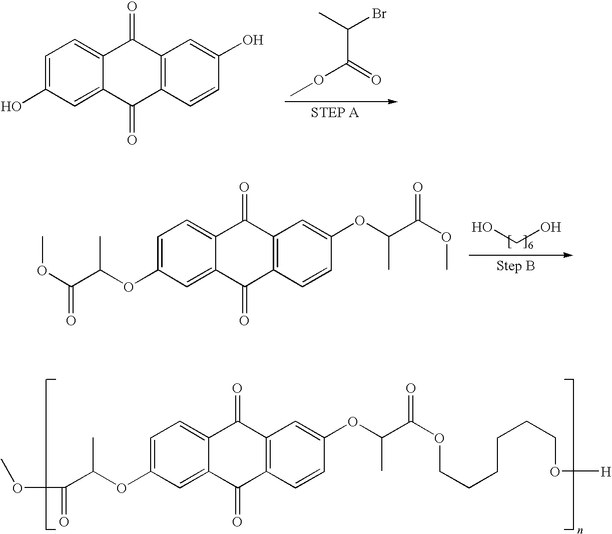

Step A: 50 g of 2,6-dihydroxyanthraquinone are dissolved in 300 ml of dimethylacetamide and while stirring, 71 g of potassium carbonate are added to the mixture. The reaction is heated at 80° C. for 1 hour, then 87 g of bromoisopropylacetate are added drop wise to the reaction mixture. The reaction mixture is then heated and maintained at 100° C. for 8 hours and after that concentrated under reduced pressure. The residue is dissolved in dichloromethane and washed several times with water. The organic phase is then concentrated under vacuum. 64.5 g of 2,6-bis(methyl ester propionoxy) 9,10-dianthraquinone are obtained as yellow solid with a melting point of 169-176° C. The proposed structure is confirmed by NMR analysis.

Step B: 64 g of 2,6-bis(methyl ester propionoxy) 9,10-dianthraquinone, 18.5 g of 1,6-hexanediol and 0.8 g of p-toluenesulfonic acid are dissolved in 300 ml of xylene. The solution is heated to reflux temperature and stirred for 10 hours. Then 300 ml of dichloromethane are added and the organic phase is washed several times with water and concentrated under reduced pressure. 68 g of the desired product (Mn=2700; n=6.1, calculated as described hereinabove) are obtained as yellow solid with a melting point of 83-93° C. The proposed structure is confirmed by NMR analysis.

Data of thermogravimetric analysis/weight loss: 260° C. 0.41%-280° C. 0.57%-300° C. 0.87%.

### Example 2

### Synthesis of

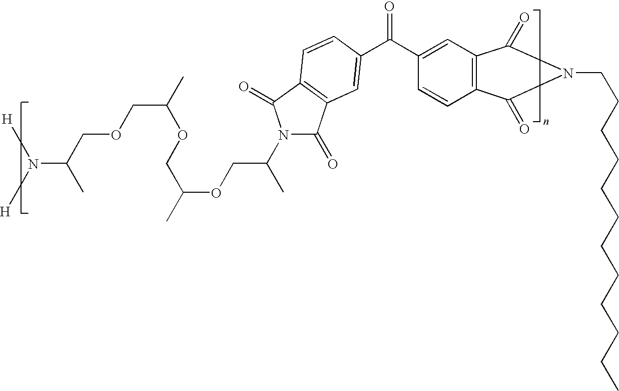

A four-necked round-bottom flask equipped with a mechanical stirrer, thermocouple, dropping funnel and condenser is charged successively with 80.0 g of 3,3′,4,4′-benzophenonetetracarboxylic dianhydride and 400 ml of glacial acetic acid. A solution of 22.9 g of dodecylamine and 42.8 g of poly(propylenglycol)bis(2-aminopropylether) are dropped to the solution at room temperature. The reaction is heated to reflux temperature for 6 hours under stirring then the mixture was poured in 400 ml of dichloromethane and the organic phase is washed several times with water and exsiccated under vacuum. The desired product is obtained as slightly yellow solid (Mn=1031; n=1.58, calculated as described hereinabove) with a melting point of 85-95° C. The proposed structure is confirmed by NMR analysis.

### Example 3

### Synthesis of

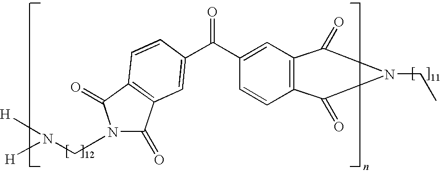

A four-necked round-bottom flask equipped with a mechanical stirrer, thermocouple, dropping funnel and condenser is charged with 122.0 g of 3,3′,4,4′-benzophenonetetracarboxylic dianhydride and 850 ml of dimethylacetamide. A solution of 37.9 g of 1,12-dodecandiamine and 73.7 g of dodecylamine dissolved in 350 ml of dimethylacetamide are dropped to the solution at room temperature. The stirred reaction is heated to reflux temperature for 3 hours. Then cooling at room temperature, the insoluble material is recovered by filtering off the crude mixture, washed with methanol and dried in oven at 50° C. under reduced pressure. 194.0 g of the desired olygomeric product are obtained as slightly yellow solid (Mn=1038; n=1.75, calculated as described hereinabove) with a melting point of 153-163° C. The proposed structure is confirmed by NMR analysis.

Data of thermogravimetric analysis/weight loss: 260° C. 1.90%-280° C. 2.00%-300° C. 2.21%.

### Example 4

### Synthesis of

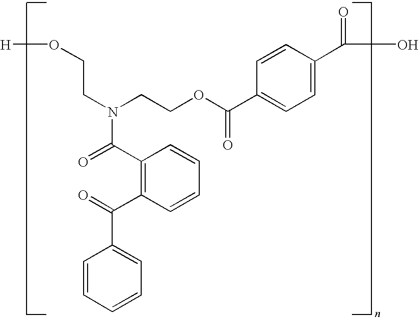

### Synthetic Steps:

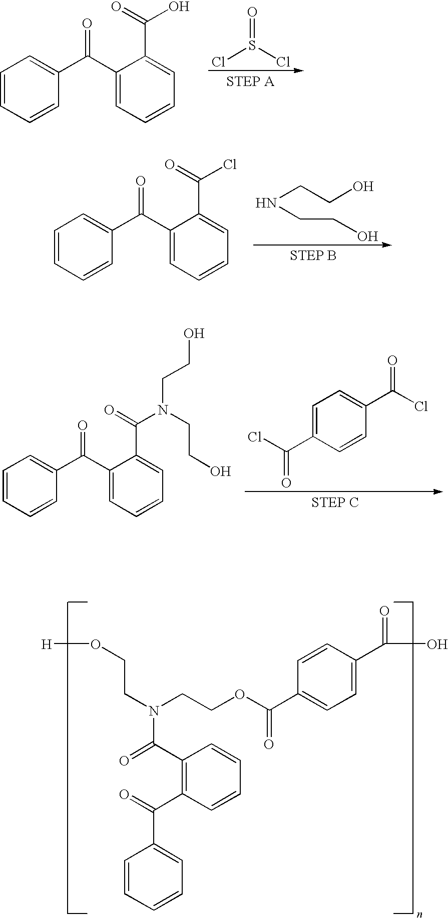

Step A: A four-necked round-bottom flask equipped with a mechanical stirrer, thermocouple, dropping funnel and condenser is charged successively with 100 g of 2-benzoyl-benzoic acid and 300 ml of dichloromethane. The mixture is cooled to 20° C. and 164 g of thionyl chloride are dropped to the solution. The reaction is heated at 38° C. for 20 hours and then concentrated under reduced pressure. 2-benzoyl-benzoyl chloride is obtained as white solid with a melting point of 66-73° C. The proposed structure is confirmed by NMR analysis.

Step B: A four-necked round-bottom flask equipped with a mechanical stirrer, thermocouple, dropping funnel and condenser is charged successively with 430 g of diethanolamine and 1000 ml of THF. The mixture is cooled to 5-10° C. and 100 g of 2-benzoyl-benzoyl chloride, as obtained in Step A, dissolved in 200 ml of THF are added drop wise. The reaction is maintained at room temperature for 20 hours. Then, the reaction mixture is concentrated and poured into dichloromethane solution. The organic phase is washed with water and concentrated under reduced pressure. 2-Benzoyl-N,N-bis-(2-hydroxy-ethyl)-benzamide is obtained as white solid with a melting point of 121-127° C. The proposed structure is confirmed by NMR analysis.

Step C: A four-necked round-bottom flask equipped with a mechanical stirrer, thermocouple, dropping funnel and condenser is charged successively with 25 g of 2-benzoyl-N,N-bis-(2-hydroxy-ethyl)-benzamide, 24.2 g of triethylamine and 350 ml of THF. 16.2 g of terephthaloyl chloride in 100 ml of THF are added drop wise, and the reaction mixture is heated at reflux temperature for 4 hours. The reaction mixture is concentrated and the crude product is washed with ethanol and water and then exsiccated under vacuum. The desired product is obtained as white solid (Mn=1103; n=2.5, calculated as described hereinabove) with a melting point of 140-147° C.

Data of thermogravimetric analysis/weight loss: 210° C. 0.95%-260° C. 1.81%-300° C. 2.15%

### Example 5

### Synthesis of

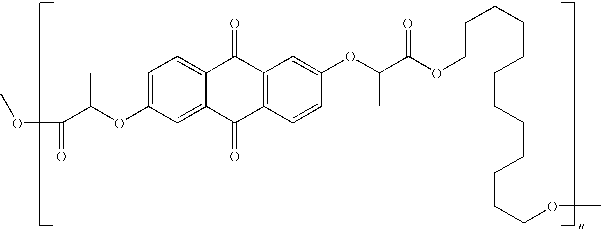

The product is afforded in analogy to the procedure reported in the Example 1 reacting 2,6-bis(methyl ester propionoxy) 9,10-dianthraquinone, as obtained in the Step A of example 1, with 1 equivalent of 1,12-dodecandiol.

Mn=4025; n=7.3

Melting point: 50-60° C.

### Example 6

### Synthesis of

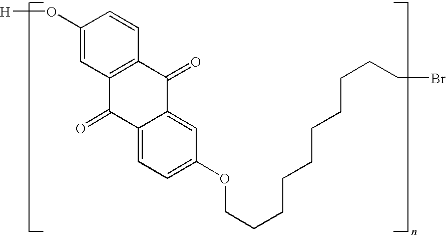

A four-necked round-bottom flask equipped with a mechanical stirrer, thermocouple, dropping funnel and condenser is charged successively with 72.0 g of 2,6-dihydroxyanthraquinone and 400 ml of dimethylacetamide. Thus, 96.6 of potassium carbonate are added to the stirred mixture heated at 55° C. and after that, 90.0 g of 1,10-dibromodecane dissolved in 100 ml of dimethylacetamide are added dropwise to the mixture. The reaction is then heated at 120° C. and left to react under stirring for 5 hours then dropped into a water solution. The formed precipitate is separated from the solution and washed several times with water, acetone and cyclohexane. The so obtained yellow solid is then further essicated in oven under vacuum. The proposed structure is confirmed by NMR analysis.

Melting point: 208-216° C.

### Example 7

### Synthesis of

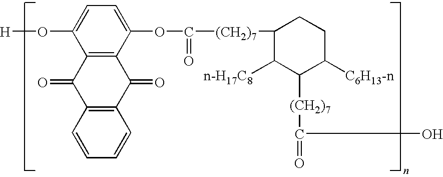

A four-necked round-bottom flask equipped with a mechanical stirrer, thermocouple, dropping funnel and condenser is charged successively with 99.7 g of “Dimer Acid Hydrogenated” and 200 ml of toluene. Thus, 44.4 g of oxalyl chloride are added to the reaction mixture and the reaction is left to react at room temperature until to the evolution of the formed CO₂ is terminated. Thus, the mixture is heated at reflux temperature for 1 hour, then cooled down to 50° C. After that, 42.0 g of quinizarine, 300 ml of dimethylacetamide and 41.5 g of pyridine are added dropwise to the solution and the reaction mixture is then left to react at 50° C. for 3 hours. The mixture is concentrated under vacuum and then dichloromethane and water are added to the residue. The organic phase is separated and concentrated under reduced pressure obtaining a red liquid as product. The proposed structure is confirmed by ¹H-NMR analysis.

Mn=1803; n=2.3

¹H-NMR (300 MHz, CDCl₃): δ 0.8-2.7 (70H, m); 7.2-8.1 (6H, m).

Data of thermogravimetric analysis/weight loss: 210° C. 0.13%-260° C. 1.09%-300° C. 4.08%

### Example 8

### Synthesis of

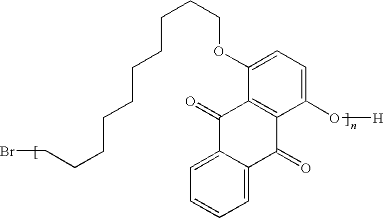

A four-necked round-bottom flask equipped with a mechanical stirrer, thermocouple, dropping funnel and condenser is charged successively with 4.8 g of quinizarine, 100 ml of dimethylacetamide. After that, 96.6 of potassium carbonate are added to the stirred mixture heated at 55° C. Thus, 90.0 g of 1,10-dibromodecane dissolved in 100 ml of dimethylacetamide are added dropwise to the reaction mixture. The reaction mixture is then heated and maintained at 120° C. for 5 hours and after that the reaction mixture is dropped to a water solution. The formed precipitate is separated from the solution, washed several times with water, acetone and cyclohexane. The so obtained yellow solid is then further essicated in oven under vacuum. The proposed structure is confirmed by NMR analysis.

Melting point: 127-135° C.

### Example 9

### Synthesis of

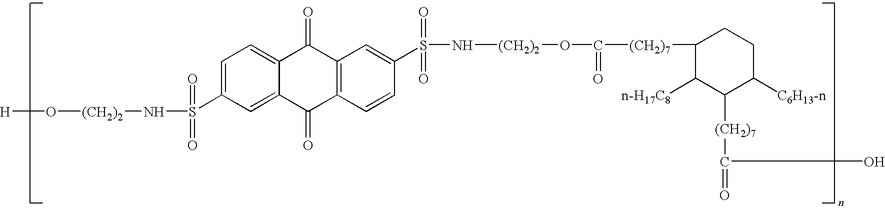

### Synthetic Steps:

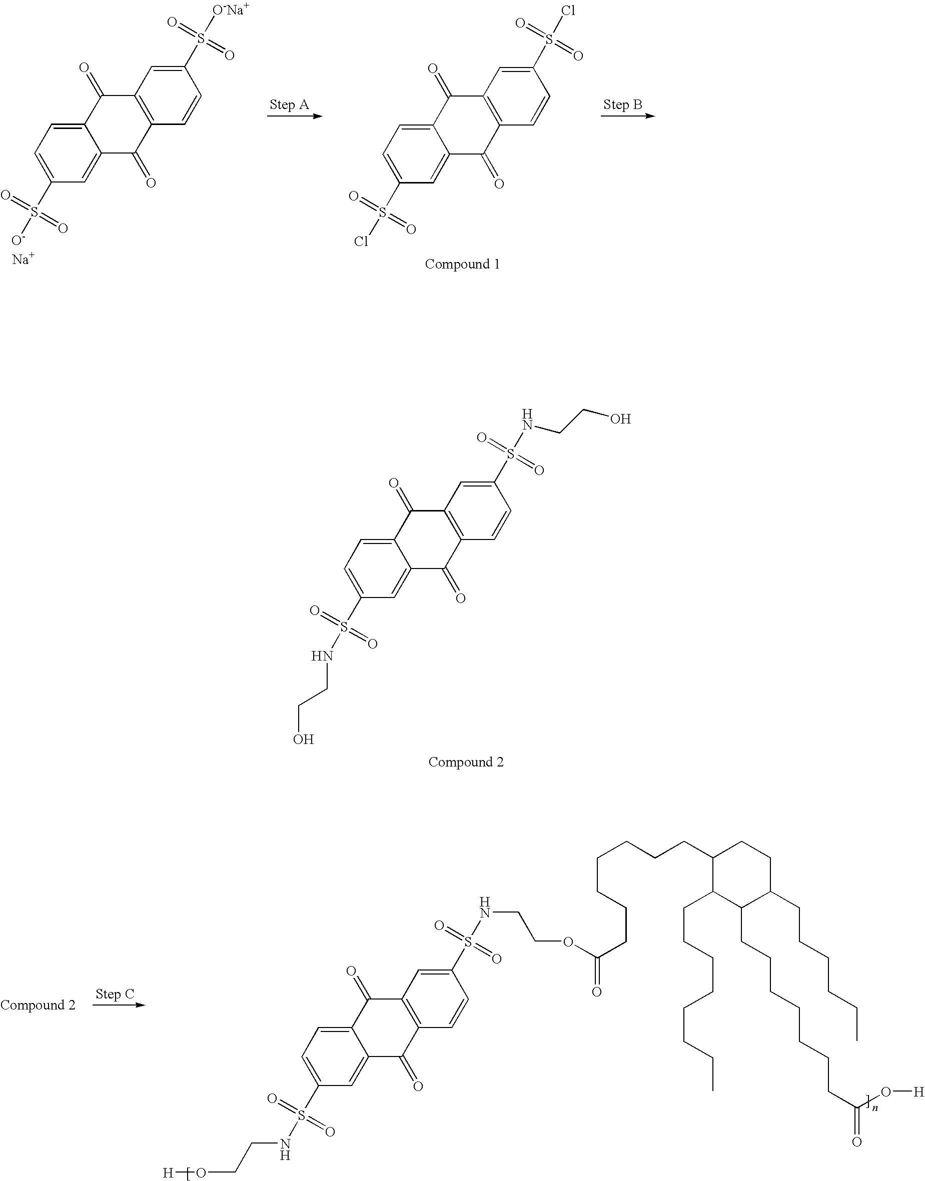

Step A: A four-necked round-bottom flask equipped with a mechanical stirrer, thermocouple, dropping funnel and condenser is charged successively with 10 g of 9,10-anthraquinone-2,6-disulfonic acid disodium salt and 200 ml of dimethylformamide. Thus, the reaction is cooled to −5° C. and after that 23.1 g of thionyl chloride are added to the mixture that is then left to react at 0° C. for 2 hours, then spontaneously at room temperature for 20 hours. Thus, the reaction is added to a water solution. The formed yellow precipitate is then separated from the solution and essicated under reduced pressure. The structure of compound 1 is confirmed by NMR analysis.

Melting point: 240-247° C.

Step B: A four-necked round-bottom flask equipped with a mechanical stirrer, thermocouple, dropping funnel and condenser is charged successively with 3.0 g of compound as obtained in the Step A of this example, 100 ml of dichloromethane and 1.8 g of ethanolamine. The reaction is left to react at 25° C. for 4 hours then the formed precipitate is separated from the solution and washed with water and methanol. The obtained white solid is then essicated under reduced pressure. The structure of compound 2 is confirmed by NMR analysis.

Melting point: 280-284° C.

Step C: The desired product is afforded in analogy to the procedure reported in the example 7 reacting 1.05 equivalent of “Dimer Acid Hydrogenated” with 1 equivalent of compound 2, as obtained in the Step B of this example The structure of the desired compound is confirmed by NMR analysis.

Mn=3044; n=3.1

Melting point: 198-207° C.

### Example 10

### Synthesis of

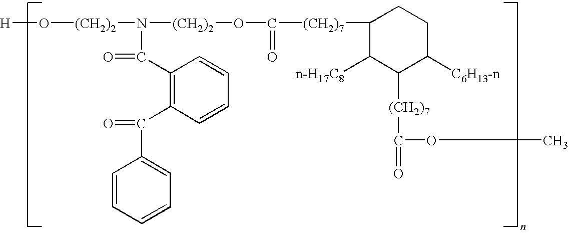

A four-necked round-bottom flask equipped with a mechanical stirrer, thermocouple and condenser is charged successively with 3.0 g of 2-benzoyl-N,N-bis-(2-hydroxy-ethyl)-benzamide, as obtained in Step B of Example 4, 5.99 g of “Dimer Acid Hydrogenated” dimethyl ester, 0.04 g of dibutyltinoxide and 60 ml of xylene. The reaction is heated at reflux temperature and left to react for 4 hours. Thus, the mixture is essicated under reduced pressure and a brown wax is obtained. The structure of the desired compound is confirmed by NMR analysis.

Mn=2683; n=3.2

¹H-NMR (300 MHz, CDCl₃): δ 0.8-2.7 (68H, m); 3.4-4.5 (8H, m); 7.2-8.4 (9H, m).

Data of thermogravimetric analysis/weight loss: 210° C. 0.49%-260° C. 1.37%-300° C. 2.73%

### Example 11

### Synthesis of

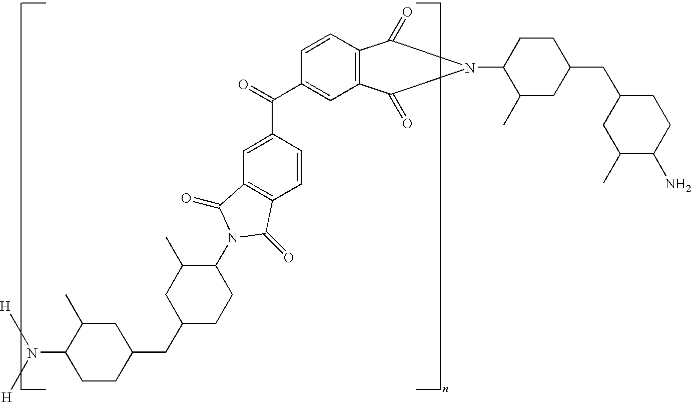

A four-necked round-bottom flask equipped with a mechanical stirrer, thermocouple and condenser is charged successively with 5.0 g of 3,3′,4,4′-benzophenonetetracarboxylic dianhydride, 3.7 g of bis(4-amino-3-methylcyclohexyl)methane and 40 ml of dimethylacetamide. Thus, the mixture is heated at 150° C. and left to react at this temperature for 2 hours. After that, the reaction is cooled to room temperature. The desired product is obtained recrystallizing with ethanol. The structure of the compound is confirmed by NMR analysis.

Melting point: 238-258° C.

### Example 12

### Synthesis of

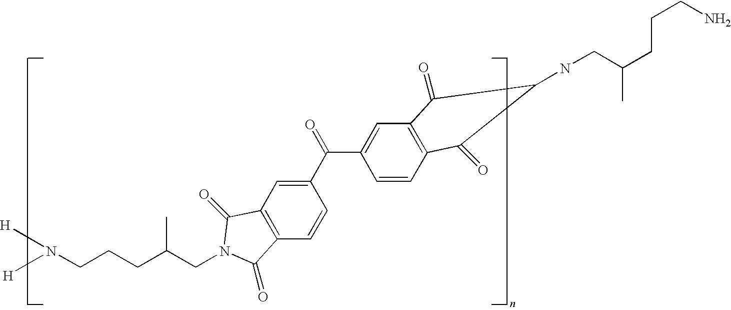

A four-necked round-bottom flask equipped with a mechanical stirrer, thermocouple and condenser is charged successively with 5.0 g of 3,3′,4,4′-benzophenonetetracarboxylic dianhydride, 1.8 g of 1,5-diamino-2-methyl-pentane and 35 ml of dimethylacetamide. Thus, the mixture is heated at 150° C. and left to react at this temperature for 2 hours. After that, the reaction is cooled to room temperature and successively water is added to the solution. The precipitated product is then separated and washed several times with water. The structure of the compound is confirmed by NMR analysis.

Melting point: 203-268° C.

### Example 13

### Synthesis of

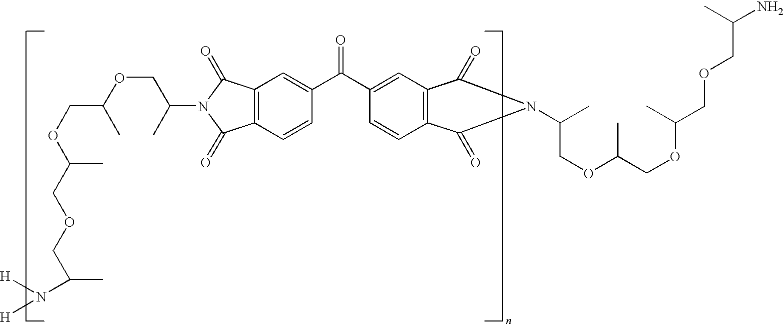

A four-necked round-bottom flask equipped with a mechanical stirrer, thermocouple and condenser is charged successively with 10.0 g of 3,3′,4,4′-benzophenonetetracarboxylic dianhydride, 7.14 g of poly(propylene glycol)bis(2-amino-propyl ether) (Mn=230) and 100 ml of glacial acetic acid. Thus, the mixture is heated at reflux temperature and left to react at this temperature for 2 hours. After that, the reaction is cooled to room temperature and successively dichloromethane and water are added to the solution. The organic phase is washed several times with water and concentrated under reduced pressure obtaining a yellow solid. The structure of the compound is confirmed by NMR analysis.

Mn=1674; n=3.1

Melting point: 125-134° C.

### Application Example A

### Application Data

### Ref.:

Example 1; Film 4
Example 2; Film 6
Example 3; Film 7
Example 4; Film 9

### Film Manufacture

50 μm thick films were obtained in the following way:

In a turbo mixer (Caccia, Labo 10) 1%, relative to the weight of the LLDPE, of the additive is mixed with LLDPE Dowlex NG 5056-E which contains 0.12% by weight of tris(2,4-di-t-butylphenyl)phosphite, 0.02% by weight of pentaerythritol tetrakis[3-(3,5-di-tert-butyl-4-hydroxyphenyl)propionate, and 0.03% by weight of octadecyl-3-(3,5-di-tert-butyl-4-hydroxyphenyl)propionate, and having a melt index of 1.1 g/10 min. (190° C./2.16 kg). The mixture is extruded at a maximum temperature of 200° C. using an O.M.C. twin-screw extruder (model ebv 19/25) to granules, which are subsequently converted to a film 50 μm thick film, using a blow-extruder (Formac™) working at a maximum temperature of 210° C.

TABLE 1
DATA SET 1 (final concentrations); Comparative Set

| Ref. | Additivation |
|---|---|
| Film 1 | None |
| Film 2 | 1% Anthraquinone (CAS-No. 84-65-1) |

(“%” means “% by weight” relative to the LLDPE)

TABLE 2
DATA SET 2 (final concentrations)

| Ref. | Additivation |
|---|---|
| Film 3 | None |
| Film 4 | 1% Example 1 |

(“%” means “% by weight” relative to the LLDPE)

25 μm thick films were obtained via masterbatches in the following way:

In a turbo mixer (Caccia, Labo 10), 10% of the additive, relative to the weight of the resin, is mixed with LLDPE Dowlex NG 5056-E. The mixture is extruded at a maximum temperature of 200° C. using an O.M.C. twin-screw extruder (model ebv 19/25), to give polymer granules, which were subsequently diluted with the same LLDPE in order to obtain the final composition and converted to a film 25 μm thick, using a blow-extruder (Dolci™) working at a maximum temperature of 210° C.

Table 3 illustrates the final composition of the LLDPE films.

TABLE 3
DATA SET 3 (final concentrations)

| Ref. | Additivation |
|---|---|
| Film 5 | None |
| Film 6 | 0.5% Example 2 |
| Film 7 | 0.5% Example 3 |

(“%” means “% by weight” relative to the LLDPE)

Other 50 μm thick films were obtained via masterbatches in the following way:

In a turbo mixer (Caccia, Labo 10) 10%, relative to the weight of the LLDPE, of the additive is mixed with LLDPE Dowlex NG 5056-G which contained 0.10% by weight of tris(2,4-di-t-butylphenyl) phosphite and 0.032% by weight of octadecyl-3-(3,5-di-tert-butyl-4-hydroxyphenyl)propionate, and having a melt index of 1.1 g/10 min. (190° C./2.16 Kg). The mixture was extruded at a maximum temperature of 200° C. using an O.M.C. twin-screw extruder (model ebv 19/25) to granules, which were subsequently diluted with the same LLDPE in order to obtain the final composition and converted to a film 50 μm thick, using a blow-extruder (Dolci™) working at a maximum temperature of 210° C.

TABLE 4
DATA SET 4 (final concentrations)

| Ref. | Additivation |
|---|---|
| Film 8 | None |
| Film 9 | 0.2% Example 4 |

(“%” means “% by weight” relative to the LLDPE)

### Exposure:

1) The film samples were exposed in an ATLAS Weatherometer (model Ci65A) equipped with a 6500 W Xenon lamp (continuous light cycle, black panel temperature=63° C.).
2) The obtained film samples were also exposed in air circulating oven (HORO 080 V) running at 40° C.

### Evaluation Parameters:

1) Carbonyl increment (CO): Evaluation of the carbonyl band increment (1710 cm⁻¹) in function of the exposure time is monitored with a FT-IR Perkin-Elmer Spectrum One.
2) Time to cracking: Visual failure of film samples was assessed according to time to the first evidence of surface cracking.
3) Blooming: the exudation of the additive out of the film is assessed visually.

### Results:

The following tables illustrate the results of carbonyl increment increase and time to cracking.

TABLE 5
Carbonyl increment in WOM exposure (in hours) of 50 μm
thick LLDPE films

| Hours | Film 3 | Film 4 |
|---|---|---|
| 215 | 0.012 | 0.066 |
| 402 | 0.045 | 0.118 |
| 611 | 0.095 | 0.199 |
| 823 | 0.178 | 0.302 |
| 1078 | 0.305 | 0.449 |
| 1281 | 0.433 | 0.584 |

TABLE 6
Time to cracking in WOM exposure (in hours) of 50 μm
thick LLDPE films

| | Film 3 | Film 4 |
|---|---|---|
| Hours to cracking | 1634 | 1033 |

TABLE 7
Carbonyl increment in WOM exposure (in hours) of 25 μm
thick LLDPE films obtained via master batch

| Hours | Film 5 | Film 6 | Film 7 |
|---|---|---|---|
| 204 | 0.004 | 0.000 | 0.017 |
| 416 | 0.024 | 0.033 | 0.061 |
| 690 | 0.072 | 0.089 | 0.124 |
| 901 | 0.121 | 0.151 | 0.177 |
| 1118 | 0.223 | — | — |
| 1285 | 0.262 | — | — |

TABLE 8
Time to cracking in WOM exposure (in hours) of 25 μm
thick LLDPE films obtained via masterbatch

| | Film 5 | Film 6 | Film 7 |
|---|---|---|---|
| Hours to cracking | 1118 | 880 | 880 |

TABLE 9
Carbonyl increment in WOM exposure (in hours) of 50 μm
thick LLDPE films obtained via masterbatch

| Hours | Film 8 | Film 9 |
|---|---|---|
| 258 | 0.011 | 0.059 |
| 467 | 0.064 | 0.117 |
| 674 | 0.122 | 0.218 |
| 862 | 0.197 | 0.324 |
| 1161 | 0.405 | 0.574 |

TABLE 10
Time to cracking in WOM exposure (in hours) of 50 μm thick
LLDPE films obtained via masterbatch

| | Film 8 | Film 9 |
|---|---|---|
| Hours to cracking | 1293 | 1081 |

TABLE 11
Blooming of in oven exposure of 50 μm thick LLDPE films

| | Film 2 | Film 4 |
|---|---|---|
| Blooming | Strong blooming just | No blooming up to |
| | after film manufacture | 1500 hours |

TABLE 12
Blooming of in oven exposure of 25 μm thick LLDPE films
obtained via masterbatch

| | Film 6 | Film 7 |
|---|---|---|
| Blooming | No blooming up to 2500 | No blooming up |
| | hours | to 5500 hours |

TABLE 13
Blooming of in oven exposure of 50 μm thick LLDPE films
obtained via masterbatch

| | Film 9 |
|---|---|
| Blooming | No blooming up to 500 hours |

Thus, the strong blooming just after film manufacture of the anthraquinone (see blooming results for Film 2) is an issue particularly undesirable when plastic products are used in contact with food or crops. On the contrary, such oligomeric photosensitizers (see blooming results for Film 4, 6, 7, 9) have shown good compatibility with the resins and can be used in plastics product when an enhanced photodegradation is required.

### The Present Invention Relates in Particular to the Following Embodiments and Preferred Embodiments

### Embodiment 1

A method for improving the degradation of natural and/or synthetic polymers or a polymer article made of such polymers by light and/or heat and/or humidity, comprising the incorporation of a compound of formula (I) into said natural and/or synthetic polymers:

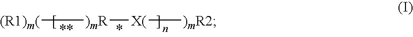

wherein
n is 1 to 100;
m is 1 or 2;
X is an m+1-valent group selected from the groups of formula (1), (2), (3) and (4):

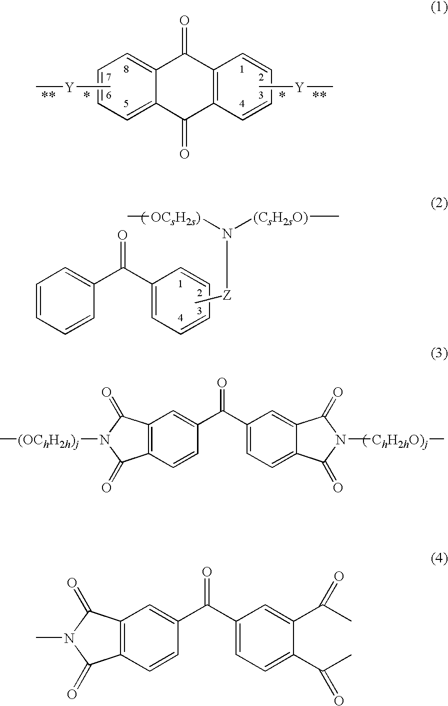

wherein
Y is a divalent group comprising 1 to 20 atoms selected from C, N, O, S and hydrogen atoms,

### Z is >(C═O) or >SO₂,

h is independently for each corresponding oxyalkylene moiety an integer from 2 to 4;
j is 0 or 1, and
s is independently for each corresponding oxyalkylene moiety an integer from 2 to 4;
R is m+1-valent group selected from:
-G-(C₂-C₃₄alkylene)-G-;
-G-(C₅-C₇cycloalkylene)-G-;
-G-(C₅-C₇cycloalkylene)-(k,k′-C₁-C₄alkylene)-(C₅-C₇cycloalkylene)-G-,
-G-(C₁-C₁₈alkylene)-(C₅-C₇cycloalkylene)-(C₁-C₁₈alkylene)-G-;
-G-(C₆-C₁₂arylene)-G-;
-G-(C₆-C₁₂arylene)-(k,k′-C₁-C₄alkylene)-(C₆-C₁₂arylene)-G-,
-G-(C₁-C₁₈alkylene)-(C₆-C₁₂arylene)-(C₁-C₁₈alkylene)-G-
   wherein said C₂-C₃₄alkylene or C₁-C₁₈alkylene groups can be unsubstituted or substituted by 1 or more substituents selected from Cl; Br; I; OH; NH₂, and C₁-C₄alkoxy, and said C₅-C₇cycloalkylene and C₆-C₁₂arylene groups can be unsubstituted or substituted by 1 or more substituents selected from Cl; Br; I; OH; NH₂, C₁-C₁₀alkyl, C₁-C₁₀alkenyl and C₁-C₁₀alkoxy,
   G is absent or is selected from —O— and >(C═O) and
   k (and k′) is 1 or 2; and
   the groups of the formulae:

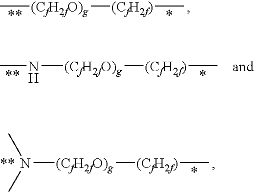

wherein each f is independently for each alkylene moiety of said groups an integer from 2 to 4, and g is from 1 to 10;
R1 is H; Cl; Br; I; OH; NH₂; a group selected from C₁-C₃₀alkyl, C₂-C₃₀alkenyl, C₁-C₃₀alkyloxy, C₂-C₃₀alkenyloxy, which groups may be unsubstituted or substituted by 1 or more of Cl; Br; I; OH; NH₂, NH(C₁-C₄alkyl), N(C₁-C₄alkyl)₂, COOH; COOC₁-C₄alkyl, C₁-C₄alkoxy; a group selected from C₃-C₁₂cycloalkyl, C₃-C₁₂cycloalkyloxy, C₅-C₁₂cycloalkenyl, C₅-C₁₂cycloalkenyl, C₆-C₁₂aryl, C₆-C₁₂aryloxy, which groups may be unsubstituted or substituted by 1 or more of Cl; Br; I; OH; NH₂, NH(C₁-C₄alkyl), N(C₁-C₄alkyl)₂, COOH; COOC₁-C₄alkyl, C₁-C₄alkyl or C₁-C₄alkoxy, or
R1 is a group —X3-R3-R4, wherein X3 is a group of formula (3) as defined above, and
R3 has one of the meanings of R wherein G is absent; and
R4 is H, NH₂, NH(C₁-C₄alkyl), N(C₁-C₄alkyl)₂, Cl, Br, I, OH, COOH, COOC₁-C₄alkyl; and
R2 is H, a group selected from C₁-C₃₀alkyl, C₂-C₃₀alkenyl, which groups may be unsubstituted or substituted by 1 or more of Cl; Br; I; OH; NH₂, NH(C₁-C₄alkyl), N(C₁-C₄alkyl)₂, COOH, COOC₁-C₄alkyl, C₁-C₄alkoxy; a group selected from C₃-C₁₂cycloalkyl, C₅-C₁₂cycloalkenyl, C₆-C₁₂aryl, which groups may be unsubstituted or substituted by 1 or more of Cl; Br; I; OH; NH₂, C₁-C₄alkyl or C₁-C₄alkoxy, or
R2 is a group —R5-R6, wherein
R5 has one of the meanings of R other than —C₂-C₃₄alkylene- and wherein G is absent; and
R6 is H, NH₂, NH(C₁-C₄alkyl), N(C₁-C₄alkyl)₂, Cl, Br, I, OH, COOH, COOC₁-C₄alkyl, C₁-C₄alkyl or C₁-C₄alkoxy; or

### R2 is —O—;

wherein the stars indicate the orientation of asymmetric groups R and Y in the formulae of said compounds.

### Embodiment 2

### A compound of formula (I) as defined in embodiment 1, with the exception of the compounds (a) and (b) of formula (II)

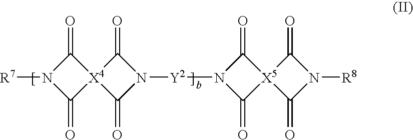

wherein
(a) R7 and R8 are C₁₋₈alkyl; X⁴ and X⁵ are -(phenyl)-CO-(phenyl)-, Y² is —CH₂-(phenylene)-CH₂— and b is 1, and
(b) R7 and R8 are 2-ethylhexyl; X⁴ and X⁵ are -(phenyl)-CO-(phenyl)-, Y² is C₁₂alkylene and b is 3.

### Embodiment 3

A compound according to embodiment 2, wherein

R is m+1-valent group selected from:
-G-(C₂-C₃₄alkylene)-G-;
-G-(C₅-C₇cycloalkylene)-G-;
-G-(C₅-C₇cycloalkylene)-(k,k′-C₁-C₄alkylene)-(C₅-C₇cycloalkylene)-G-,
-G-(C₂-C₁₈alkylene)-(C₅-C₇cycloalkylene)-(C₂-C₁₈alkylene)-G-;
-G-(C₆-C₁₂arylene)-G-;
-G-(C₆-C₁₂arylene)-(k,k′-C₁-C₄alkylene)-(C₆-C₁₂arylene)-G-,
-G-(C₂-C₁₈alkylene)-(C₆-C₁₂arylene)-(C₂-C₁₈alkylene)-G-
   wherein said C₂-C₃₄alkylene or C₂-C₁₈alkylene groups can be unsubstituted or substituted by 1 or more substituents selected from Cl; Br; I; OH; NH₂, and C₁-C₄alkoxy, and said C₅-C₇cycloalkylene and C₆-C₁₂arylene groups can be unsubstituted or substituted by 1 or more substituents selected from Cl; Br; I; OH; NH₂, C₁-C₁₀alkyl, C₁-C₁₀alkenyl and C₁-C₁₀alkoxy,
   G is absent or is selected from —O— and >(C═O) and
   k (and k′) is 1 or 2; and
   the groups of the formulae:

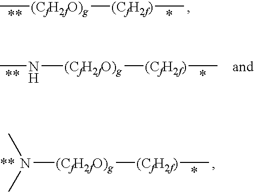

wherein each f is independently for each alkylene moiety of said groups an integer from 2 to 4, and g is from 1 to 10; and
R1 is H; Cl; Br; I; OH; NH₂; a group selected from C₁-C₃₀alkyl, C₂-C₃₀alkenyl, C₁-C₃₀alkyloxy, C₂-C₃₀alkenyloxy, which groups may be unsubstituted or substituted by 1 or more of Cl; Br; I; OH; NH₂, NH(C₁-C₄alkyl), N(C₁-C₄alkyl)₂, COOH; COOC₁-C₄alkyl, C₁-C₄alkoxy; a group selected from C₃-C₁₂cycloalkyl, C₃-C₁₂cycloalkyloxy, C₅-C₁₂cycloalkenyl, C₅-C₁₂cycloalkenyl, C₆-C₁₂aryl, C₆-C₁₂aryloxy, which groups may be unsubstituted or substituted by 1 or more of Cl; Br; I; OH; NH₂, NH(C₁-C₄alkyl), N(C₁-C₄alkyl)₂, COOH; COOC₁-C₄alkyl, C₁-C₄alkyl or C₁-C₄alkoxy, or
R1 is a group —X3-R3-R4, wherein X3 is a group of formula (3) as defined above, and
R3 has one of the meanings of R other than —(C₂-C₈alkylene)- and wherein G is absent; and
—R4 is H, NH₂, NH(C₁-C₄alkyl), N(C₁-C₄alkyl)₂, Cl, Br, I, OH, COOH, COOC₁-C₄alkyl.

### Embodiment 4

A compound according to embodiment 2 or 3, wherein

R1 is selected from:
H; Cl, Br, OH; NH₂; a group selected from C₁-C₄alkyl and C₁-C₄alkoxy, or
R1 is a group —X3-R3-R4, wherein X3 is a group of formula (3) as defined above, and
R3 is —(C₉-C₂₀alkylene)-; and

### R4 is H.

### Embodiment 5

A compound according to any one of embodiments 2 to 4, wherein

R2 is selected from H, C₁-C₄alkyl and C₁₀-C₂₀alkyl, which groups may be unsubstituted or substituted by 1, 2 or 3 of Cl; Br; I; OH; NH₂ or C₁-C₄alkoxy; or
R2 is a group —R5-R6, wherein
R5 has one of the meanings of R other than —C₂-C₃₄alkylene- and wherein G is absent; and

### R6 is H or NH₂; or

### R2 is —O—.

### Embodiment 6

A compound according to any one of embodiments 2 to 5, wherein X in formula (I) is a group selected from the groups

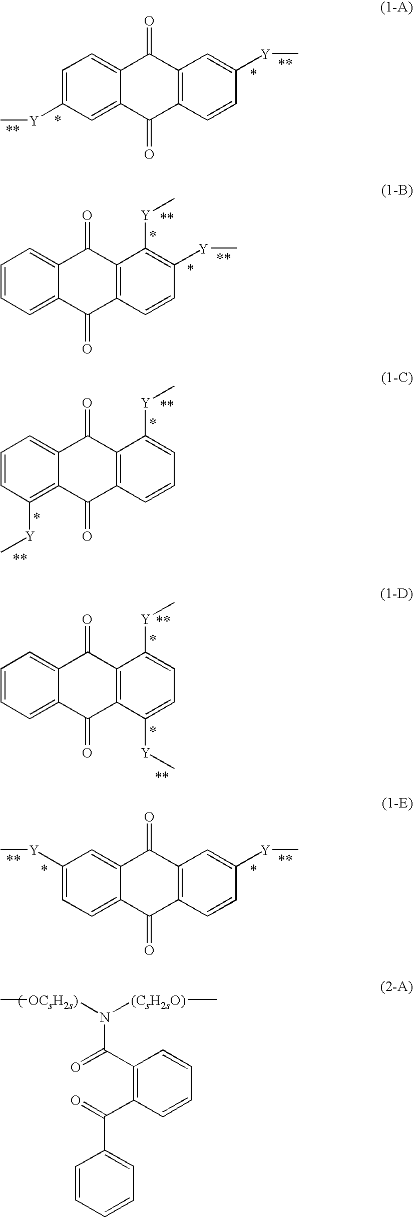

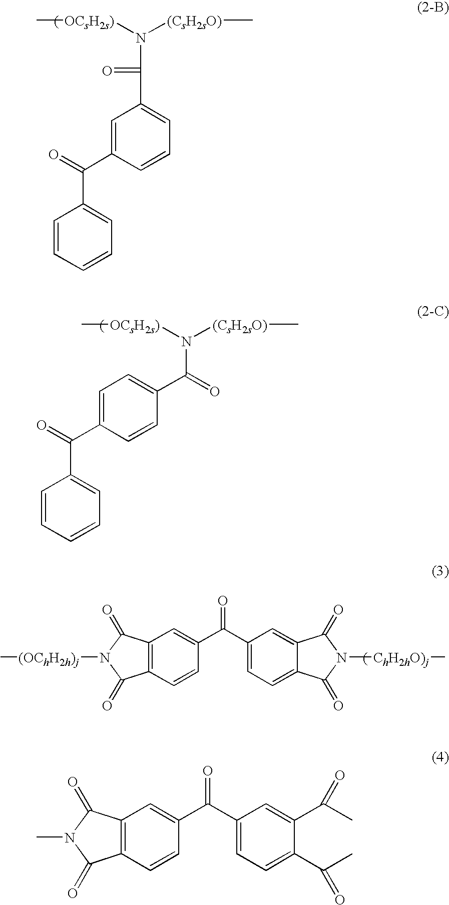

wherein Y, h, j and s have the meaning defined in embodiment 2.

### Embodiment 7

A compound according to any one of embodiments 2 to 6, wherein Y is selected from the groups:

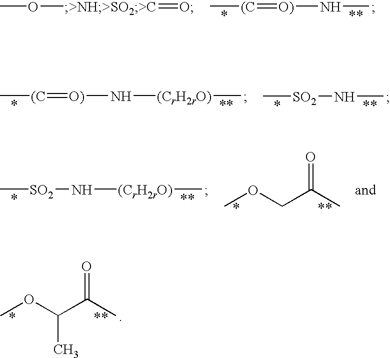

wherein r is an integer from 2 to 4, preferably 2 or 3.

### Embodiment 8

A compound according to any one of embodiments 2 to 7, wherein m is 1.

### Embodiment 9

A compound according to any one of embodiments 2 to 8, wherein

n is 1 to 7;
X is an m+1-valent group selected from the groups of formula (I-A) oder (3-A):

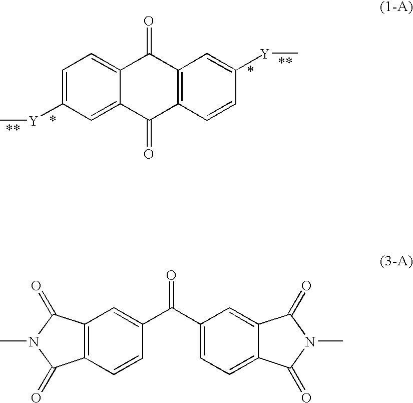

wherein
Y is selected from the groups:

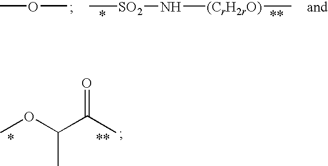

R is a group selected from:
C₆-C₁₂alkylene and -G-(C₆-C₁₂alkylene)-G-;
wherein said C₆-C₁₂alkylene groups can be unsubstituted or substituted by 1, 2 or 3 substituents selected from Cl; Br; I; OH; NH₂, and C₁-C₄alkoxy, and

### G is —O—;

R1 is C₁-C₁₂alkyl or C₁-C₁₂alkyloxy, or, if X is a group of formula (3-A) may also be a group —X3-R3-R4, wherein X3 is a group of formula (3-A),
R3 is C₉-C₂₀alkylene; and

### R4 is H; and

R2 is H or C₆-C₁₂alkyl, unsubstituted or substituted by 1, 2 or 3 substituents selected from Cl; Br; I; OH; NH₂, and C₁-C₄alkoxy.

### Embodiment 10

A compound according to any one of embodiments 2 to 9, having a formula selected from:

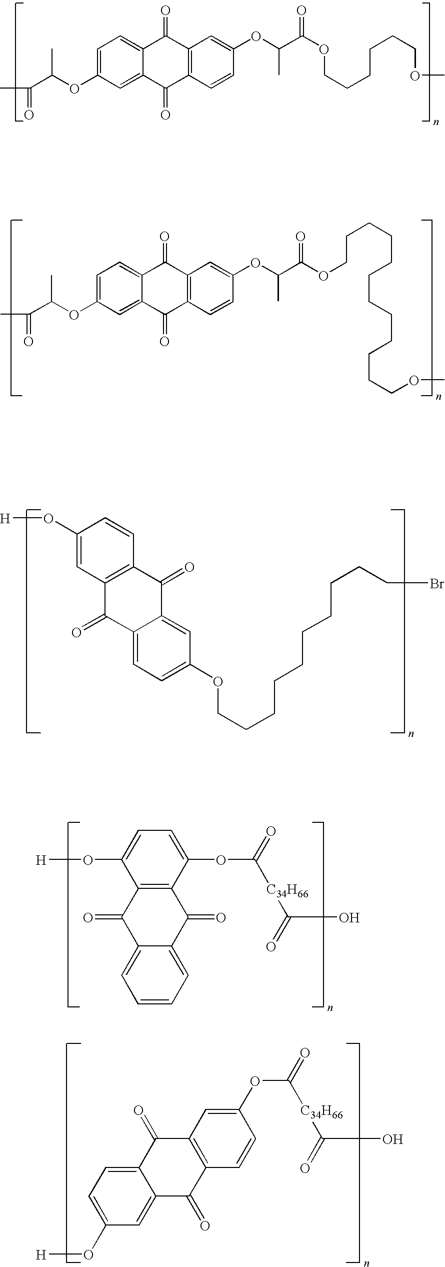

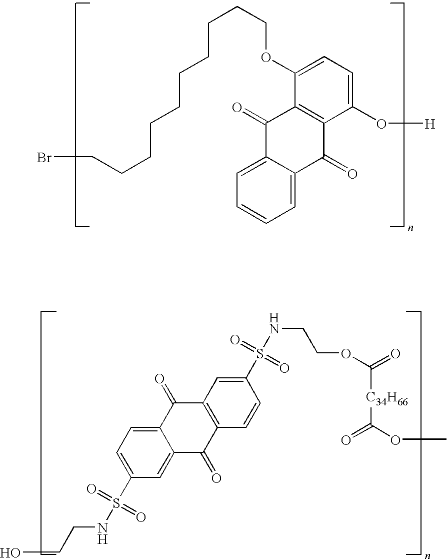

wherein n is as defined in embodiment 2 to 9.

### Embodiment 11

A compound according to any one of embodiments 2 to 8, having a formula selected from:

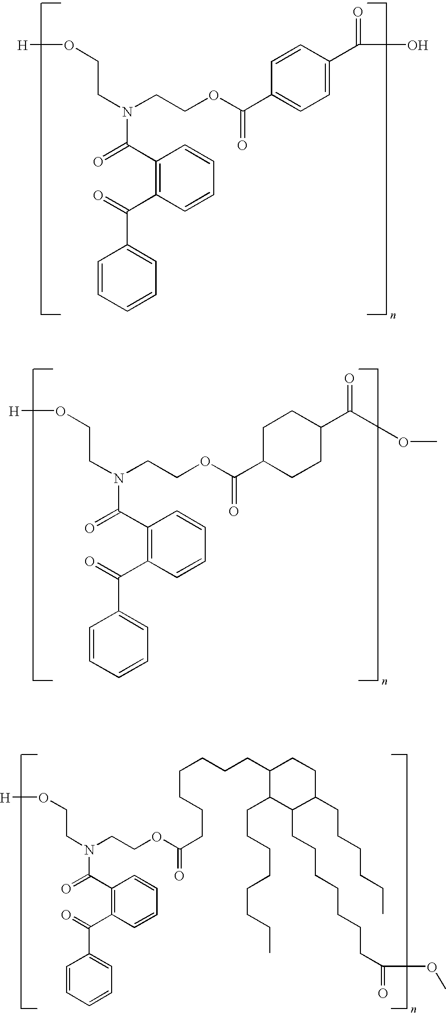

wherein n is as defined in embodiments 2 to 9.

### Embodiment 12

A compound according to any one of embodiments 2 to 9, having a formula selected from:

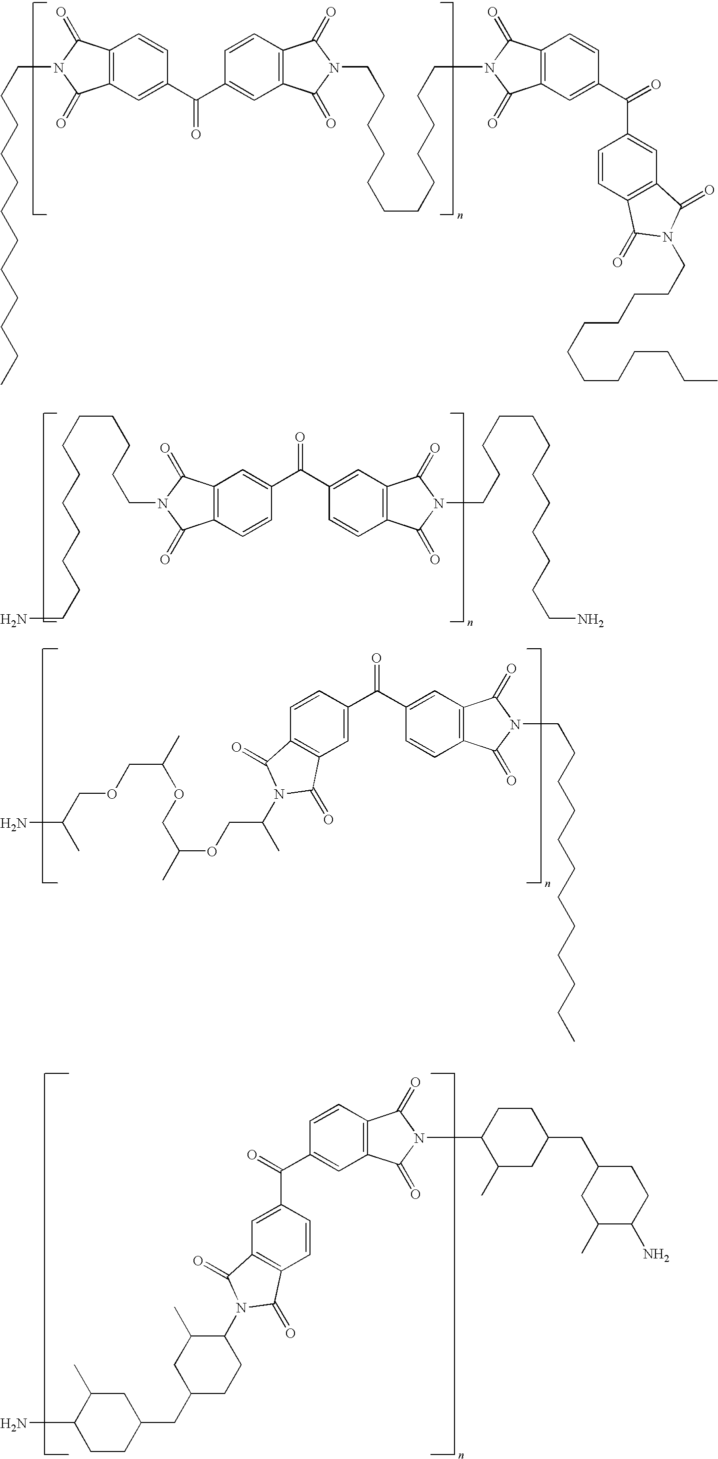

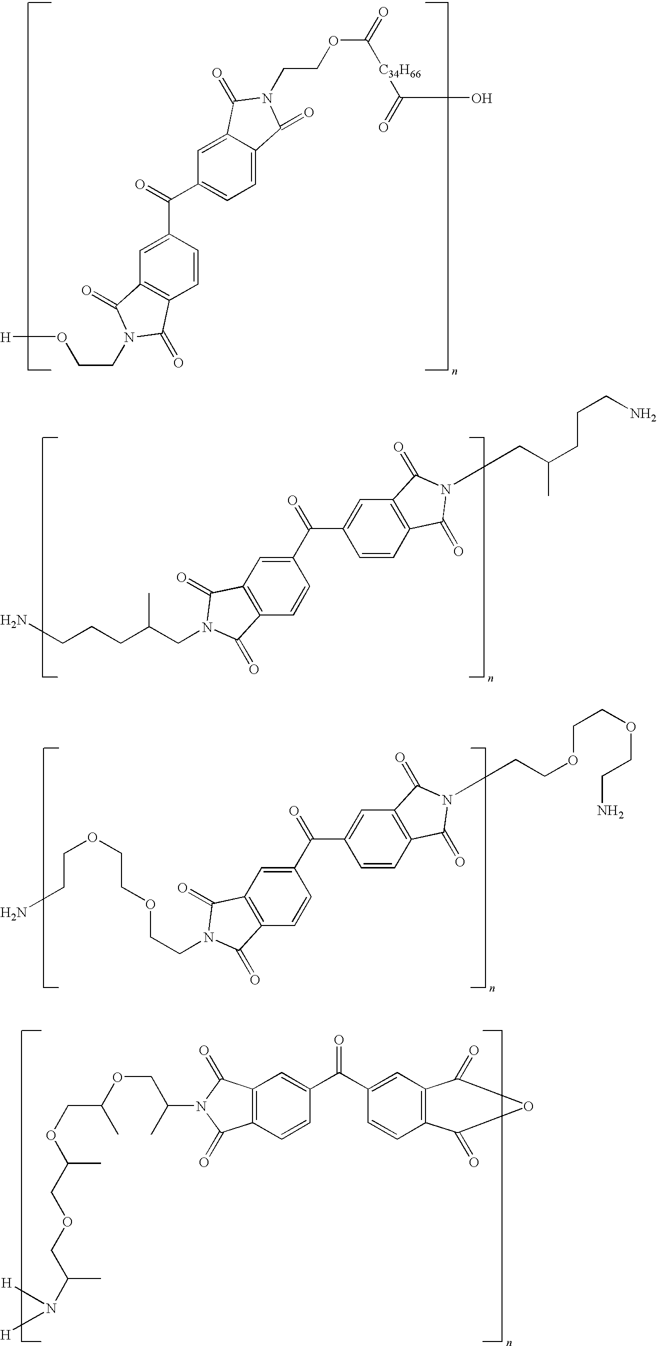

wherein n is as defined in embodiments 2 to 9.

### Embodiment 13

The compound of formula

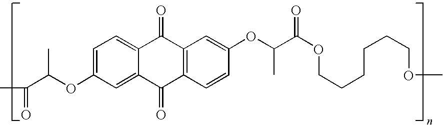

having a number-average molecular weight (Mn) of about 2740 g/mol and a melting range of 83° to 93° C.; or of formula

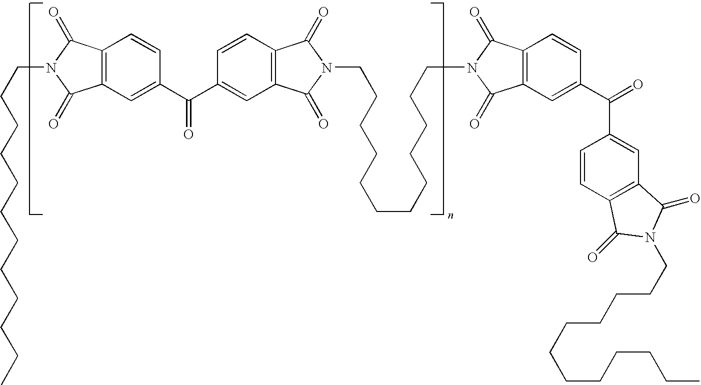

having a number-average molecular weight (Mn) of about 1040 g/mol and a melting range of 166° to 174° C.

### Embodiment 14

A polymer article which is degradable in the presence of light and/or heat and/or humidity being made of a composition comprising:

(A) a natural and/or a synthetic polymer and
(B) a degradation accelerator being a compound of formula (1) as described in embodiment 1.

### Embodiment 15

A polymer article according to embodiment 14, wherein the degradation accelerator is a compound of formula (I) as defined in any one of embodiments 2 to 13.

### Embodiment 16

A polymer article according to embodiment 14 or 15, wherein component (A) is a thermoplastic synthetic polymer.

### Embodiment 17

A polymer article according to any one of embodiments 14 to 16, wherein component

(A) is a polyolefin homo- or copolymer, a polyester homo- or copolymer, a polyamide homo- or copolymer, a blend thereof, a starch modified polyolefin or a starch based polymer composite.

### Embodiment 18

A polymer article according to any one of embodiments 14 to 17, wherein component

(A) is polyethylene, polypropylene, a polyethylene copolymer or a polypropylene copolymer.

### Embodiment 19

A polymer article according to any one of embodiments 14 to 18, wherein the composition, of which it is made, additionally contains

(C) an inorganic or organic salt of a transition metal.

### Embodiment 20

A polymer article according to any one of embodiments 14 to 19, wherein the composition additionally contains one or more of the following components

(D-I) a filler or reinforcing agent,
(D-II) a pigment,
(D-III) a light stabilizer,
(D-IV) a processing additive,
(D-V) an antioxidant,
(D-VI) an inorganic or organic salt of Ca, Mg, Zn or Al, or an oxide of Ca, Mg, Zn or Al,
(D-VII) a terpene derivative,
(D-VIII) an inorganic oxidant selected from inorganic peroxides and or superoxides.

### Embodiment 21

A polymer article according to any one of embodiments 14 to 20, which is an agricultural article.

### Embodiment 22

A polymer article according to embodiment 21, wherein the agricultural article is selected from the group consisting of mulch films, small tunnel films, row covers, banana bags, direct covers, nonwoven, twines and pots.

### Embodiment 23

A polymer article according to any one of embodiment 14 to 22, which is a monolayer or three-layers mulch film having a thickness of 5 to 100 microns, said polymer article being optionally being partially burned.

### Embodiment 24

A polymer article according to any one of embodiments 14 to 20, which is a packaging material and/or which is used for consumer products.

### Embodiment 25

A polymer article according to embodiment 24, wherein the packaging material is for food, beverage or cosmetics.

### Embodiment 26

A polymer article according to any one of embodiments 14 to 20, which is a hygienic or medical article.

### Embodiment 27

A polymer article according to any one of embodiments 14 to 26, which is selected from the group consisting of films, fibers, profiles, bottles, tanks, containers, sheets, bags, styrofoam cups, plates, blister packages, boxes, package wrappings and tapes.

### Embodiment 28

A polymer article according to any one of embodiments 14 to 27 which is shaped by injection-molding, blow-molding, compression-molding, roto-molding, slush-molding, extrusion, film casting, film blowing, calendering, thermoforming, spinning or rotational casting.

### Embodiment 29

The use of a compound of the formula (I) as defined in embodiment 1, optionally in combination with an inorganic or organic salt of a transition metal as oxygen scavenger in food packaging.

1. A method for improving the degradation of natural and/or synthetic polymers or a polymer article made of such polymers by light and/or heat and/or humidity, comprising the incorporation of a compound of formula (I) into said natural and/or synthetic polymers 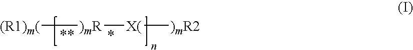
wherein
n is 1 to 100;
m is 1 or 2;
X is an m+1-valent group selected from the groups of formula (1), (2), (3) and (4) 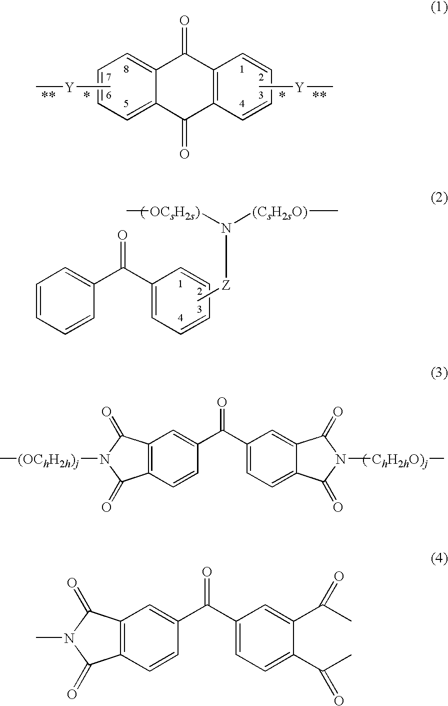
wherein
Y is a divalent group comprising 1 to 20 atoms selected from C, N, O, S and hydrogen atoms;
Z is >(C═O) or >SO₂;
h is independently for each corresponding oxyalkylene moiety an integer from 2 to 4;
j is 0 or 1 and
s is independently for each corresponding oxyalkylene moiety an integer from 2 to 4;
R is a m+1-valent group selected from
-G-(C₂-C₃₄alkylene)-G-,
-G-(C₅-C₇cycloalkylene)-G-,
-G-(C₅-C₇cycloalkylene)-(k,k′-C₁-C₄alkylene)-(C₅-C₇cycloalkylene)-G-,
-G-(C₁-C₁₈alkylene)-(C₅-C₇cycloalkylene)-(C₁-C₁₈alkylene)-G-,
-G-(C₆-C₁₂arylene)-G-,
-G-(C₆-C₁₂arylene)-(k,k′-C₁-C₄alkylene)-(C₆-C₁₂arylene)-G- and
-G-(C₁-C₁₈alkylene)-(C₆-C₁₂arylene)-(C₁-C₁₈alkylene)-G-
wherein said C₂-C₃₄alkylene or C₁-C₁₈alkylene groups are unsubstituted or substituted by 1 or more substituents selected from C, B, I, OH, NH₂ and C₁-C₄alkoxy, and said C₅-C₇cycloalkylene and C₆-C₁₂arylene groups are unsubstituted or substituted by 1 or more substituents selected from Cl, Br, I, OH, NH₂, C₁-C₁₀alkyl, C₁-C₁₀alkenyl and C₁-C₁₀alkoxy;
G is absent or is selected from —O— and >(C═O) and
k (and k′) is 1 or 2;
or R is a group of formulae 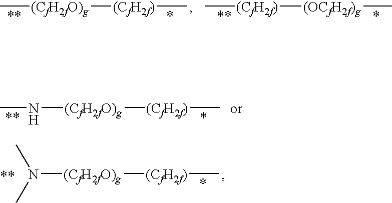
wherein each f is independently for each alkylene moiety of said groups an integer from 2 to 4 and g is from 1 to 10;
R1 is H, C, Br, I, OH or NH₂ or is a group selected from C₁-C₃₀alkyl, C₂-C₃₀alkenyl, C₁-C₃₀alkyloxy and C₂-C₃₀alkenyloxy, which groups are unsubstituted or substituted by 1 or more Cl, Br, I, OH, NH₂, NH(C₁-C₄alkyl), N(C₁-C₄alkyl)₂, COOH, COOC₁-C₄alkyl or C₁-C₄alkoxy; or R1 is a group selected from C₃-C₁₂cycloalkyl, C₃-C₁₂cycloalkyloxy, C₅-C₁₂cycloalkenyl, C₅-C₁₂cycloalkenyl, C₆-C₁₂aryl and C₆-C₁₂aryloxy, which groups are unsubstituted or substituted by 1 or more Cl, Br, I, OH, NH₂, NH(C₁-C₄alkyl), N(C₁-C₄alkyl)₂, COOH, COOC₁-C₄alkyl, C₁-C₄alkyl or C₁-C₄alkoxy, or R1 is a group —X3-R3-R4, wherein X3 is a group of formula (3);
R3 has one of the meanings of R wherein G is absent;
R4 is H, NH₂, NH(C₁-C₄alkyl), N(C₁-C₄alkyl)₂, Cl, Br, I, OH, COOH or COOC₁-C₄alkyl;
R2 is H, or is a group selected from C₁-C₃₀alkyl, C₂-C₃₀alkenyl and C₁-C₃₀alkyloxy, which groups are unsubstituted or substituted by 1 or more Cl, Br, I, OH, NH₂, NH(C₁-C₄alkyl), N(C₁-C₄alkyl)₂, COOH, COOC₁-C₄alkyl or C₁-C₄alkoxy, or R2 is a group selected from C₃-C₁₂cycloalkyl, C₅-C₁₂cycloalkenyl and C₅-C₁₂aryl, which groups are unsubstituted or substituted by 1 or more Cl, Br, I, OH, NH₂, C₁-C₄alkyl or C₁-C₄alkoxy, or R2 is a group —R5-R6;
R5 has one of the meanings of R other than —C₂-C₃₄alkylene- and wherein G is absent;
R6 is H, NH₂, NH(C₁-C₄alkyl), N(C₁-C₄alkyl)₂, Cl, Br, I, OH, COOH, COOC₁-C₄alkyl, C₁-C₄alkyl or C₁-C₄alkoxy; or
R2 is —O—; and
wherein the stars indicate the orientation of asymmetric groups R and Y in the formulae of said compounds.

2. A compound of the formula (I) according to claim 1 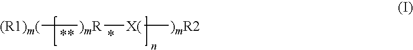
with the exception of the compounds (a) and (b)

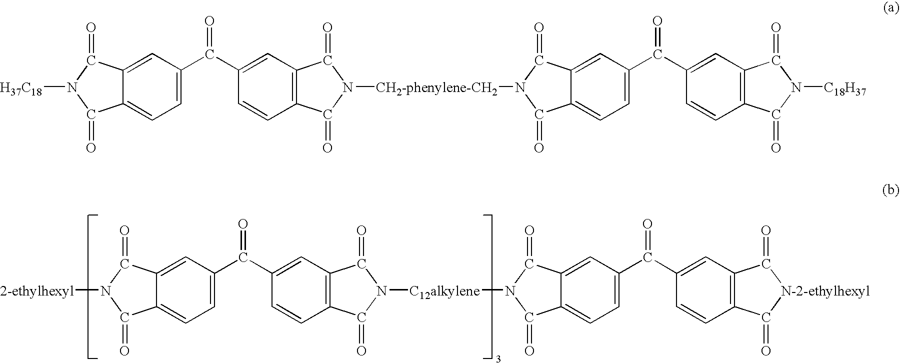

3. A compound according to claim 2 wherein
R is m+1-valent group selected from
-G-(C₂-C₃₄alkylene)-G-
-G-(C₅-C₇cycloalkylene)-G-
-G-(C₅-C₇cycloalkylene)-(k,k′-C₁-C₄alkylene)-(C₅-C₇cycloalkylene)-G-,
-G-(C₂-C₁₈alkylene)-(C₅-C₇cycloalkylene)-(C₂-C₁₈alkylene)-G-
-G-(C₆-C₁₂arylene)-G-
-G-(C₆-C₁₂arylene)-(k,k′-C₁-C₄alkylene)-(C₆-C₁₂arylene)-G- and
-G-(C₂-C₁₅alkylene)-(C₆-C₁₂arylene)-(C₂-C₁₈alkylene)-G-
wherein said C₂-C₃₄alkylene or C₂-C₁₅alkylene groups are unsubstituted or substituted by 1 or more substituents selected from Cl, Br, I, OH, NH₂ and C₁-C₄alkoxy, and said C₅-C₇cycloalkylene and C₆-C₁₂arylene groups are unsubstituted or substituted by 1 or more substituents selected from Cl, Br, I, OH, NH₂, C₁-C₁₀alkyl, C₁-C₁₀alkenyl and C₁-C₁₀alkoxy;
G is absent or is selected from —O— and >(C═O) and
k (and k′) is 1 or 2; and
or R is a group of the formulae 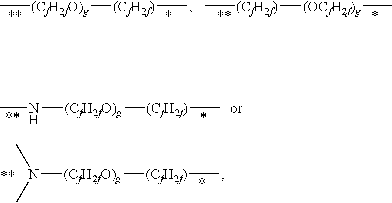
wherein each f is independently for each alkylene moiety of said groups an integer from 2 to 4 and g is from 1 to 10;
R1 is H, Cl, B, I, OH, NH₂, or is a group selected from C₁-C₃₀alkyl, C₂-C₃₀alkenyl, C₁-C₃₀alkyloxy and C₂-C₃₀alkenyloxy, which groups are unsubstituted or substituted by 1 or more Cl, Br, I, OH, NH₂, NH(C₁-C₄alkyl), N(C₁-C₄alkyl)₂, COOH, COOC₁-C₄alkyl or C₁-C₄alkoxy; or R1 is a group selected from C₃-C₁₂cycloalkyl, C₃₋₁₂-cycloalkyloxy, C₅-C₁₂cycloalkenyl, C₅-C₁₂cycloalkenyl, C₆-C₁₂aryl and C₆-C₁₂aryloxy, which groups are unsubstituted or substituted by 1 or more Cl, Br, I, OH, NH₂, NH(C₁-C₄alkyl), N(C₁-C₄alkyl)₂, COOH, COOC₁-C₄alkyl, C₁-C₄alkyl or C₁-C₄alkoxy, or R1 is a group —X3-R3-R4, wherein X3 is a group of formula (3);
R3 has one of the meanings of R other than —(C₂-C₈alkylene)- and wherein G is absent; and
R4 is H, NH₂, NH(C₁-C₄alkyl), N(C₁-C₄alkyl)₂, Cl, Br, I, OH, COOH or COOC₁-C₄alkyl.

4. A compound according to claim 2 wherein
R1 is H, Cl, Br, OH or NH₂ or is a group selected from C₁-C₄alkyl and C₁-C₄alkoxy, or R1 is a group —X3-R3-R4, wherein X3 is a group of formula (3);
R3 is —(C₉-C₂₀alkylene)-;
R4 is H;
R2 is selected from H or is a group selected from C₁-C₄alkyl, C₁₀-C₂₀alkyl and C₁-C₄alkyloxy, which groups are unsubstituted or substituted by 1, 2 or 3 Cl, Br, I, OH, NH₂ or C₁-C₄alkoxy, or
R2 is a group —R5-R6, wherein
R5 has one of the meanings of R other than —C₂-C₃₄alkylene- and wherein G is absent; and
R6 is H or NH₂; or
R2 is —O—.

5. A compound according to claim 2 wherein
X in formula (I) is a group selected from (1-A), (1-B), (1-C), (1-D), (1-E), (2-A), (2-B), (2-C), (3) and (4)

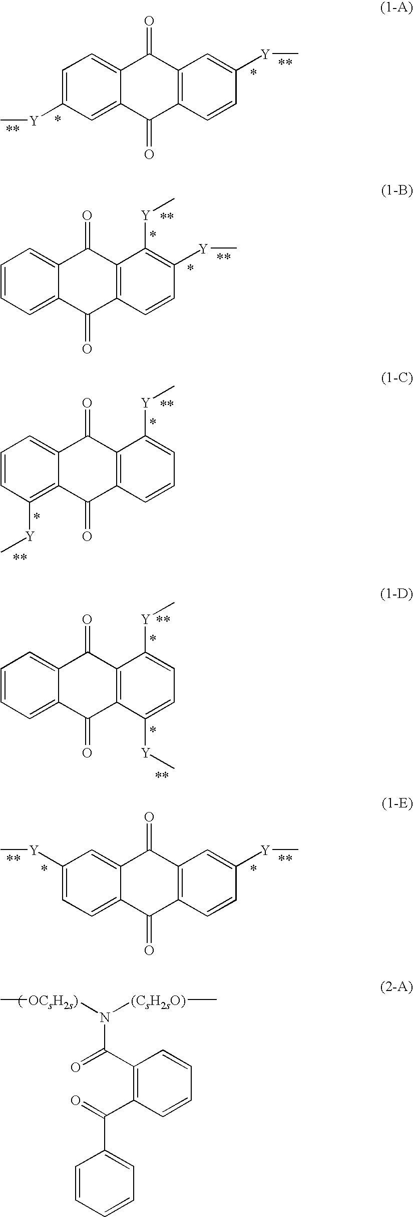

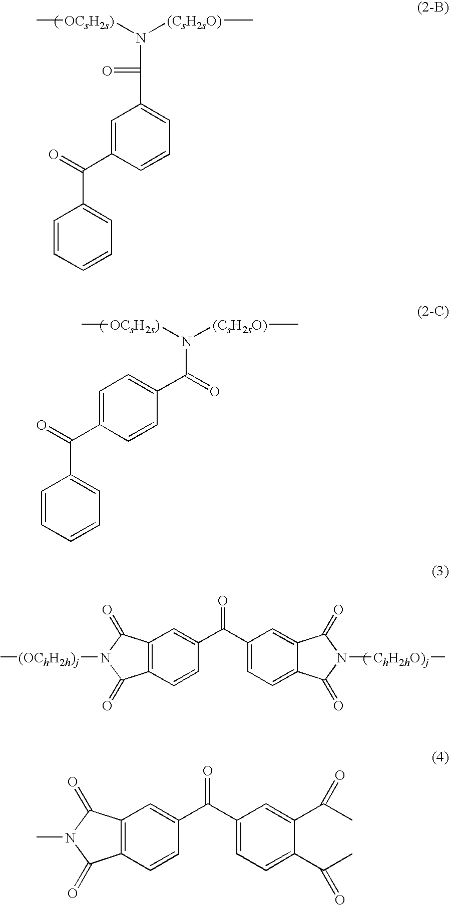

6. A compound according to claim 2 wherein
Y is selected from —O—, >NH, >SO₂, >C═O, 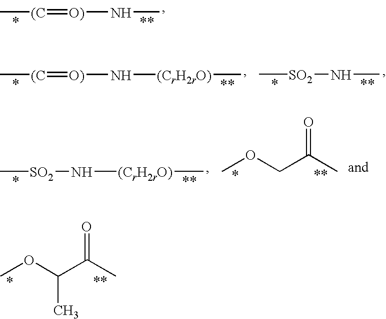
wherein r is an integer from 2 to 4.

7. A compound according to claim 2 wherein
n is 1 to 7;
X is a m+1-valent group (1-A) or (3-A) 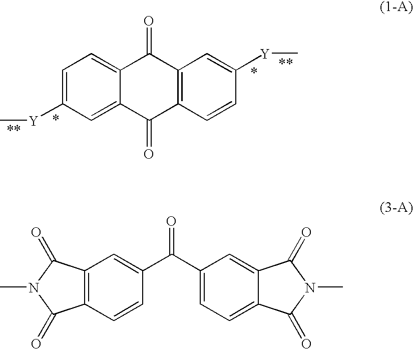
wherein
Y is selected from the groups 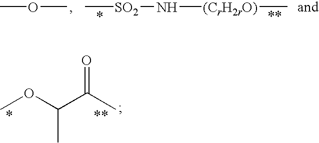
R is a group C₆-C₁₂alkylene or -G-(C₆-C₁₂alkylene)-G-;
wherein said C₆-C₁₂alkylene groups are unsubstituted or substituted by 1, 2 or 3 substituents selected from Cl, Br, I, OH, NH₂ and C₁-C₄alkoxy;
G is —O—;
R1 is C₁-C₁₂alkyl or C₁-C₁₂alkyloxy, or, if X is a group of formula (3-A) may also be a group —X3-R3-R4;
R3 is C₉-C₂₀alkylene; and
R4 is H; and
R2 is H or C₆-C₁₂alkyl which is unsubstituted or substituted by 1, 2 or 3 substituents selected from Cl, Br, I, OH, NH₂ and C₁-C₄alkoxy.

8. A compound according to claim 2, which corresponds to the formula (I-a) 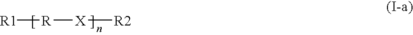
wherein
n is a number from 1 to 10;
X is a group of the formula (1-A), (1-D), (2-A) or (3-A) 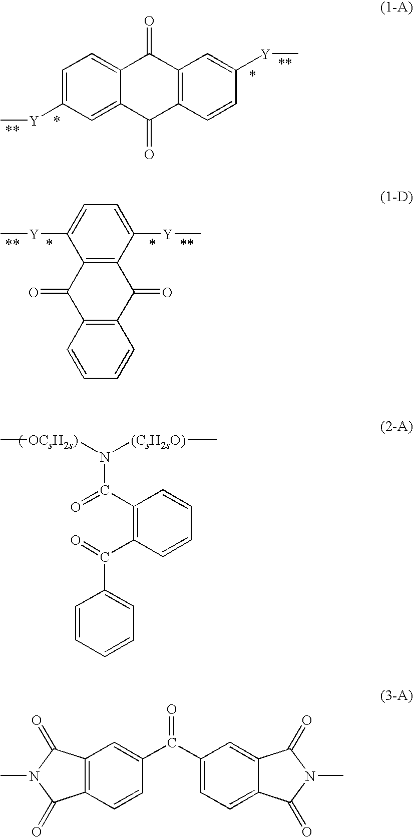
Y is —O— or a group of the formula 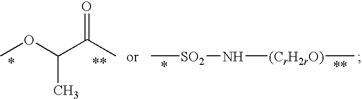
s is 2;
r is 2;
R is C₆-C₁₂alkylene, —O—(C₆-C₁₂alkylene)-O—, —CO-phenylene-CO—, -cyclohexylene-(C₁-C₆alkylene)-cyclohexylene wherein the cyclohexylene groups are unsubstituted or substituted by 1 to 3 C₁-C₄alkyl,
a group 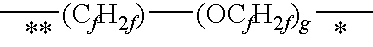
wherein each f is independently for each alkylene moiety an integer from 2 to 4 and g is an integer from 1 to 10, or is
a group of the formula 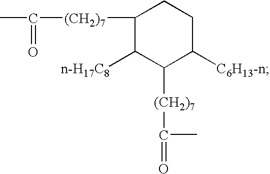
R1 is hydrogen, —Br, —OH, —NH₂, C₁-C₄alkyl or C₁-C₄alkyloxy; and
R2 is hydrogen, C₁-C₁₈alkyl, C₁-C₄alkyloxy, -cyclohexylene-(C₁-C₆alkylene)-cyclohexylene-NH₂ wherein the cyclohexylene groups are unsubstituted or substituted by 1 to 3 C₁-C₄alkyl, —(C₁-C₁₈alkylene)-NH₂ or is a group 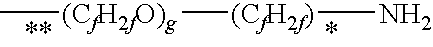
wherein each f is independently for each alkylene moiety an integer from 2 to 4 and g is an integer from 1 to 10.

9. A compound according to claim 2, which is selected from the group consisting of (1-a), (1-b), (1-c), (1-d), (1-e), (1-f), (2-a), (2-b), (3-a), (3-b), (3-c), (3-d) and (3-e) 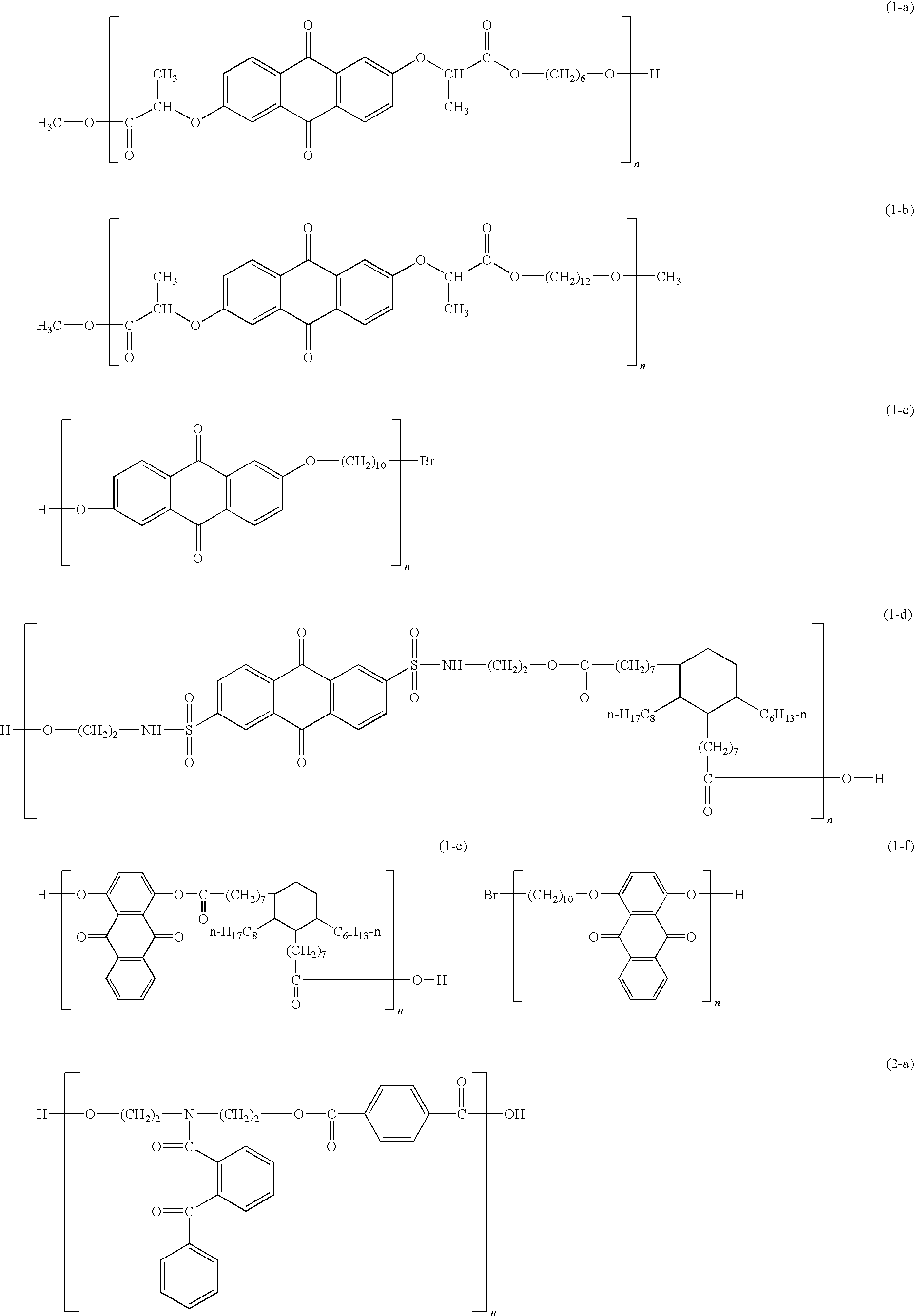 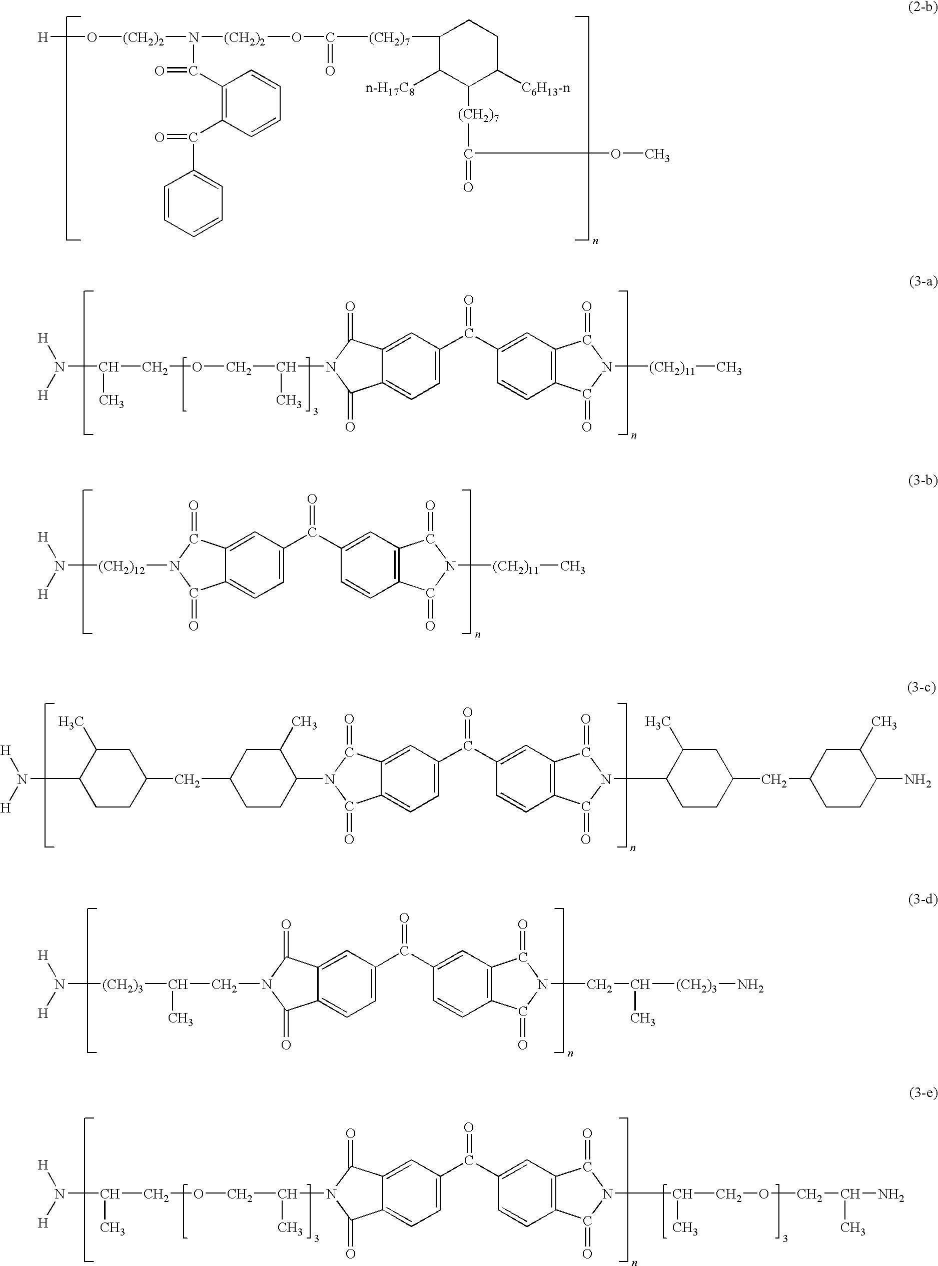
wherein n is a number from 1 to 10.

10. A polymer article which is degradable in the presence of light and/or heat and/or humidity being made of a composition comprising
(A) a natural and/or a synthetic polymer and
(B) a compound of formula (I) according to claim 1.

11. A polymer article according to claim 10 wherein component
(A) is polyethylene, polypropylene, a polyethylene copolymer or a polypropylene copolymer.

12. A polymer article according to claim 10 wherein the composition additionally contains
(C) an inorganic or organic salt of a transition metal.

13. A polymer article according to claim 10 wherein the composition additionally contains one or more components selected from
(C) an inorganic or organic salt of a transition metal,
(D-I) a filler or reinforcing agent,
(D-II) a pigment,
(D-III) a light stabilizer,
(D-IV) a processing additive,
(D-V) an antioxidant,
(D-VI) an inorganic or organic salt of Ca, Mg, Zn or Al, or an oxide of Ca, Mg, Zn or Al,
(D-VII) a terpene derivative and
(D-VIII) inorganic peroxide or superoxide oxidants.

14. A polymer article according to claim 10, which is an agricultural article selected from the group consisting of mulch films, small tunnel films, row covers, banana bags, direct covers, nonwoven, twines and pots.

15. A polymer article according to claim 10, which is a packaging material for consumer products.
